(19) United States
(12) Patent Application Publication
(10) Pub. No.: US 2023/0088291 A1
(43) Pub. Date: Mar. 23, 2023

(54) COMPUTATIONAL STORAGE DRIVE

(71) Applicant: Kioxia Corporation, Tokyo (JP)

(72) Inventors: Ayako TSUJI, Yokohama (JP); Kazunari SUMIYOSHI, Yokohama (JP); Keito TAI, Yokohama (JP)

(73) Assignee: Kioxia Corporation, Tokyo (JP)

(21) Appl. No.: 17/654,912

(22) Filed: Mar. 15, 2022

(30) Foreign Application Priority Data
Sep. 22, 2021 (JP) 2021-153872

(51) Int. Cl. G06F 3/06

(52) U.S. Cl. CPC G06F 3/0655; G06F 3/0604; G06F 3/0679

(57) ABSTRACT

According to one embodiment, a computational storage drive, comprises a first memory configured to store a program, a storage medium configured to store data, a processor configured to execute the program, and a controller configured to perform, control of an asynchronous event which is a process independent of a request from a host. The controller is configured to transmit an asynchronous event notification to the host when an asynchronous event set by the host occurs.

### CROSS-REFERENCE TO RELATED APPLICATIONS

This application is based upon and claims the benefit of priority from Japanese Patent Application No. 2021-153872, filed Sep. 22, 2021, the entire contents of which are incorporated herein by reference.

### FIELD

Embodiments described herein relate generally to a computational storage drive.

### BACKGROUND

A computational storage drive (hereinafter referred to as CSD) is known. The CSD is a storage drive with a computational function therein. The CSD is able to perform computational operations inside the storage drive, the operations needed to be performed by a host CPU in a host to which a storage drive without computational functions is connected. This can reduce the overhead of data transmission between the host and the storage drive and reduce the load on the host CPU.

Conventional CSDs are not capable of performing a computational operation in association with internal events executed therein.

### BRIEF DESCRIPTION OF THE DRAWINGS

FIG. 1 is a block diagram of an example of an information processing system including a computational storage drive (CSD) and a host according to an embodiment.

FIG. 2 is a diagram illustrating details of the CSD according to the embodiment.

FIG. 3 is a diagram illustrating an example of the host receiving an asynchronous notification from the CSD and acquiring information.

FIG. 4 is a diagram illustrating the status of a unit in the CSD according to the embodiment.

FIG. 5 is a diagram illustrating an example of host write in the CSD according to the embodiment.

FIG. 6 is a diagram illustrating an invalid data storing unit generated by the host write in the CSD according to the embodiment.

FIG. 7 is a diagram illustrating a start of a garbage collection by the CSD according to the embodiment.

FIG. 8 is a diagram illustrating an example in which data in the valid data storing unit is moved in the garbage collection by the CSD according to the embodiment.

FIG. 9 is a diagram illustrating an example in which a lookup table is updated in the garbage collection by the CSD according to the embodiment.

FIG. 10 is a diagram illustrating an example in which a zone is allocates as a free zone in the garbage collection by the CSD according to the embodiment.

FIG. 11 is a block diagram illustrating an example of an asynchronous notification setting by the CSD according to the embodiment.

FIG. 12 is a block diagram illustrating an example of an internal event-driven startup function by the CSD according to the embodiment.

FIG. 13 is a timing diagram illustrating an example of the internal event-driven startup function by the CSD according to the embodiment.

FIG. 14 is a timing diagram illustrating another example of the internal event-driven startup function by the CSD according to the embodiment.

FIG. 15 is a timing diagram illustrating still another example of the internal event-driven startup function by the CSD according to the embodiment.

FIG. 16 is a timing diagram illustrating still another example of the internal event-driven startup function by the CSD according to the embodiment.

FIG. 17 is a diagram illustrating an example of host commands for the internal event-driven startup function by the CSD according to the embodiment.

FIG. 18 is a diagram illustrating another example of host commands for the internal event-driven startup function by the CSD according to the embodiment.

FIG. 19 is a diagram illustrating still another example of host commands for the internal event-driven startup function by the CSD according to the embodiment.

FIG. 20 is a diagram illustrating still another example of host commands for the internal event-driven startup function by the CSD according to the embodiment.

FIG. 21 is a diagram illustrating still another example of host commands for the internal event-driven startup function by the CSD according to the embodiment.

FIG. 22 is a diagram illustrating still another example of host commands for the internal event-driven startup function by the CSD according to the embodiment.

FIG. 23 is a diagram illustrating an example of host commands for a garbage collection (GC)-driven startup function by the CSD according to the embodiment.

FIG. 24 is a diagram illustrating another example of host commands for the GC-driven startup function by the CSD according to the embodiment.

FIG. 25 is a diagram illustrating an example of the GC-driven startup function by the CSD according to the embodiment.

FIG. 26 is a diagram illustrating an example of the status of the CSD according to the embodiment when there is data modification.

FIG. 27 is a diagram illustrating an example of the status of the CSD according to the embodiment when there is no data modification.

FIG. 28 is a diagram illustrating another example of the status of the CSD according to the embodiment when there is data modification.

FIG. 29 is a diagram illustrating another example of the status of the CSD according to the embodiment when there is no data modification.

FIG. 30 is a diagram illustrating another example of the GC-driven startup function by the CSD according to the embodiment.

FIG. 31 is a diagram illustrating still another example of the GC-driven startup function by the CSD according to the embodiment.

FIG. 32 is a diagram illustrating still another example of host commands for the GC-driven startup function by the CSD according to the embodiment.

FIG. 33 is a flowchart illustrating an example of the GC-driven startup function by the CSD according to the embodiment.

FIG. 34 is a diagram illustrating still another example of the GC-driven startup function by the CSD according to the embodiment.

FIG. 35 is a diagram illustrating still another example of the GC-driven startup function by the CSD according to the embodiment.

FIG. 36 is a diagram illustrating still another example of the GC-driven startup function by the CSD according to the embodiment.

FIG. 37 is a diagram illustrating still another example of the GC-driven startup function by the CSD according to the embodiment.

FIG. 38 is a diagram illustrating still another example of the GC-driven startup function by the CSD according to the embodiment.

FIG. 39 is a diagram illustrating still another example of the GC-driven startup function by the CSD according to the embodiment.

FIG. 40 is a diagram illustrating still another example of the GC-driven startup function by the CSD according to the embodiment.

FIG. 41 is a diagram illustrating still another example of the GC-driven startup function by the CSD according to the embodiment.

FIG. 42 is a diagram illustrating still another example of the GC-driven startup function by the CSD according to the embodiment.

FIG. 43 is a diagram illustrating an operation in still another example of the GC-driven startup function by the CSD according to the embodiment.

FIG. 44 is a diagram illustrating another operation in still another example of the GC-driven startup function by the CSD according to the embodiment.

FIG. 45 is a diagram illustrating still another operation in still another example of the GC-driven startup function by the CSD according to the embodiment.

FIG. 46 is a diagram illustrating still another example of the GC-driven startup function by the CSD according to the embodiment.

FIG. 47 is a diagram illustrating still another example of the GC-driven startup function by the CSD according to the embodiment.

FIG. 48 is a diagram illustrating still another example of the GC-driven startup function by the CSD according to the embodiment.

FIG. 49 is a diagram illustrating an example of data conversion by the CSD according to the embodiment.

FIG. 50 is a diagram illustrating another example of the data conversion by the CSD according to the embodiment.

FIG. 51 is a diagram illustrating an example of a compaction of log by the CSD according to the embodiment.

FIG. 52 is a diagram illustrating an example of order change of physical addresses by the CSD according to the embodiment.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes, and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

In general, according to one embodiment, a computational storage drive includes a first memory configured to store a program; a second memory configured to be accessed when the program is executed; a storage medium configured to store data from a host; a processor configured to execute the program and to perform data processing with respect to the data stored in the second memory or the storage medium; and a controller configured to perform, upon a request from the host, data write to the storage medium, data read from the storage medium, or control of an asynchronous event which is a process independent of the request from the host. The program is configured to issue an asynchronous event notification when an asynchronous event occurs. The controller is configured to transmit the asynchronous event notification to the host when the controller is allowed by the host to transmit the asynchronous event notification.

Embodiments describe a computational storage drive (hereinafter referred to as CSD) in which startup of computational program (hereinafter referred to as CPRG) to execute the computational functions is in association with various internal events executed inside the CSD. In this way, the degree of freedom in design of startup timing of CPRG for CSD users is increased. Furthermore, by delaying the execution of non-time-sensitive CPRG until the timing of the occurrence of internal events of the storage drive, the power consumption of the storage drive can be reduced.

Furthermore, embodiments are related to a technique of linking CPRG startup to, among other internal events, garbage collection (hereinafter referred to as GC) in the CSD including internal flash translation layer (hereinafter referred to as FTL).

In the conventional technology, when an application needs to read, process, and write back a large amount of data stored in the CSD, the data read and the data write back by the GC may overlap with the above processings. By linking the GC with the CPRG startup, this overlap can be eliminated, the performance of the CSD can be improved, and the life of the CSD can be extended.

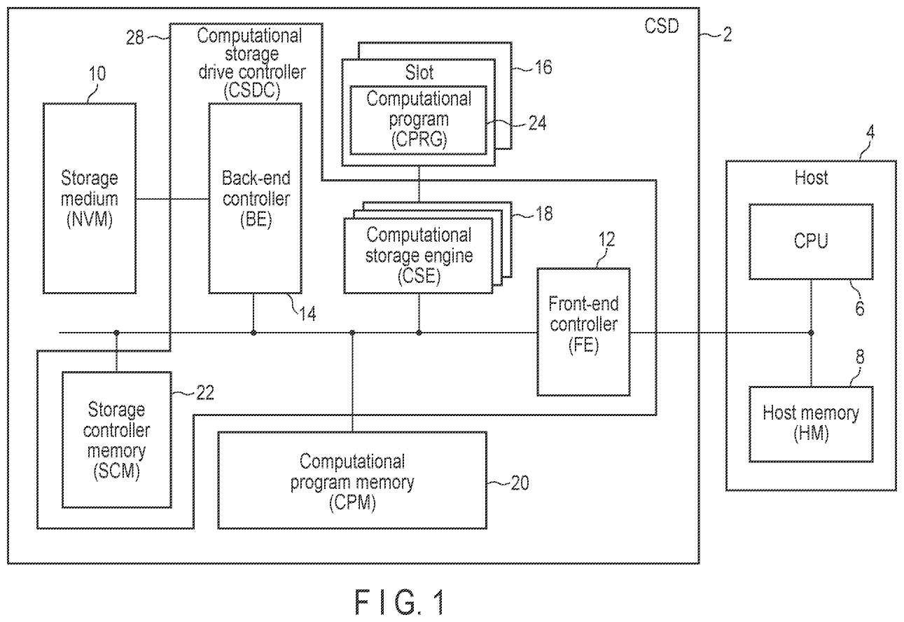

FIG. 1 is a block diagram of an example of an information processing system including a CSD 2 according to an embodiment and host 4. With reference to FIG. 1, technologies related to the CSD 2, CPRG, FTL, and GC are described below. Note that, there is no universally accepted terminology for describing the elements of these technologies, and even the same term is often used with different meanings by different users. For this reason, the following explanation is provided for the purpose of defining the terms in this specification. That is, “to be referred” in this specification means “to be referred in this instance”.

The host 4 includes a CPU 6 and a host memory (hereinafter referred to as HM) as functional modules.

The CSD 2 includes several functional modules. Examples of functional modules of the CSD 2 are a storage medium 10, a front-end controller (hereinafter referred to as FE) 12, a back-end controller (hereinafter referred to as BE) 14, a slot 16, a computational storage engine (hereinafter referred to as CSE) 18, a computational program memory (hereinafter referred to as CPM) 20, and a storage controller memory (hereinafter referred to as SCM) 22.

The storage medium 10 is a physical medium to store data written by the host 4. An example of the storage medium 10 is a non-volatile memory (hereinafter referred to as NVM). An example of the nonvolatile memory is a NAND flash memory or a magnetic disk.

The FE 12 is a module to control communication with the host 4. The FE 12 analyzes commands transmitted from the host 4, and distributes the commands to BE 14 and CSEs 18 in the later stages. The FE 12 performs a management of the whole CSD which is not performed by the BE 14 or CSEs 18. The FE 12 includes a processor that operates based on a program to perform the above processes. The FE 12 may also include a hardware to perform some of these processes.

The BE 14 is a module that controls the storage medium 10. The BE 14 controls the storage medium 10 to store data transmitted from the host 4 in response to a write request from the host 4, and to read data from the storage medium 10 in response to a read request from the host 4. The BE 14 controls the FTL. The BE 14 includes a processor that operates based on a program to perform the above processes. The BE 14 may also include a hardware to perform some of these processes.

The slot 16 is an area to store the CPRG 24. One or more slots 16 can be provided in the CSD 2. The slot 16 can store the CPRGs 24 of the number thereof. The distinction between the CPRGs 24 is performed based on the slot number. The slot 16 includes, for example, a DRAM.

The CSE 18 performs computational storage control commands (hereinafter referred to as CS commands) from the host 4 and computational storage control (hereinafter called as CS control) in response to CS control requests from the BE 14 and FE 12. One or more CSEs 18 can be provided in the CSD 2. The CSE 18 is a hardware that executes the CPRG 24. The CSE 18 is, for example, a processor. When the CPRG 24 is executed, a group of information such as a stack required for program execution is expanded in a particular memory. This expanded memory image referred to as a CPRG instance. The same CPRG 24 can be used to startup multiple CPRG instances simultaneously. When multiple CSEs 18 are provided, it is possible to execute multiple CPRG instances for the number of CSEs 18 at the same time. The same CPRG 24 may be executed as multiple CPRG instances simultaneously.

The CPRG 24 is a program that is stored in the slot 16 and executed with the CSE 18. The CPRG 24 includes a fixed CPRG which is and fixedly implemented on the CSD 2 by a vendor of the CSD 2, and a downloadable CPRG which is downloaded to the CSD 2 by a user of the CSD 2. The handling of arguments and return values of the CPRG 24 and the startup method of the CSD 24 are described later.

The CPM 20 is a RAM area accessible from the CPRG 24. The CPM 20 can be used to transmit data to and from the HM 8 and transmit data to and from the storage medium 10. The CPM 20 incudes, for example, a DRAM.

The SCM 22 is a RAM area required for processes of the FE 12 and BE 14. The SCM 22 includes, for example, a SRAM.

Note that, the BE 14, FE 12, SCM 22, CSE 18 may not be distinguished, and may be referred to as a CSD controller (CSDC) 28. The CSDC 28 may be configured as a single packaged device. The CSDC 28 may be configured as an SoC.

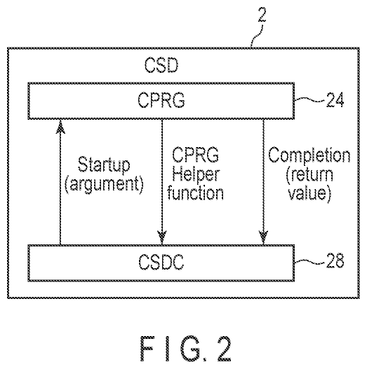

FIG. 2 is a diagram illustrating a relationship between the CPRG 24 and CSDC 28. The CSDC 28 starting the execution of the CPRG 24 is called “startup”. The startup may be accompanied with arguments. When the CPRG 24 finishes its execution, it can return a return value to the CSDC 28.

Control interface for making settings and queries to the CSDC 28 while the CPRG 24 is executed referred to as a CPRG helper function.

[Arguments and Return Values for CPRG 24]

The CPRG 24 can use arguments. The argument referred to as a CPRG parameter. The CPRG parameter can include either host parameters transmitted from the host 4 or CSD parameters transmitted from the CSDC 28, or both.

An example of the CPRG parameter structure is as follows.

{
host_param,
csd_param
}

The “host_param” is a host parameter transmitted from the host 4 to the CSD 2. It can also be a pointer to a set of parameters placed in the CPM 20. A CSD user can freely decide what to transmit as the host parameter from the host 4 when designing the CPRG 24.

The “csd_param” is a CSD parameter transmitted from the CSD 2 to the host 4. It can also be a pointer to a set of parameters placed in the CPM 20.

In the specification, the host parameters are used in the following functions, which are described later.

[Internal event-Driven CPRG startup function with host parameter setting function]

[GC driven CPRG startup function (basic type)]

H_SET_GC_DRIVEN_CPRG_HOST_PARAM( )

[SRC single unit, GC driven CPRG startup function].

When these functions are combined with the host parameter setting function, it is possible to make more flexible conditional decisions between the host 4 and the CSD. An example of the decisions is that a process is performed by a request for which an LUA range. The LUA is a type of logical address which is described later.

In this function, the host parameter can be used, for example, to represent the range information of LUA where the CPRG 24 executes data conversion process.

The CPRG 24 may return a return value in the end of process.

Here, It is defined that the CPRG of a conventional CSD to return the following return values.

The conventional CSD is a CSD that do not have a mechanism to trigger CPRG in association with internal events.

{
host_ret
csd_ret
}

The “host_ret” is a return value transmitted from the CSD 2 to the host 4, and it may be a pointer to a set of parameters placed in the CPM 20.

The “csd_ret” is a return value transmitted from the host 4 to the CSD 2, and it may be a pointer to a parameter set placed in the CPM 20.

Here, the CPRG startup method refers to a method in which the CSD 2 executes the CPRG 24. Examples of the CPRG startup method in the conventional CSD are as follows.

(1) CPRG Execution Command-Driven Startup Method

The CPRG execution command-driven startup method is a method that is executed by the CPRG execution command. The CPRG execution command is a command issued by the host 4 to the CSD 2.

(2) I/O Command-Driven Startup Method

The I/O command-driven startup method is a method in which the CPRG 24 is executed in association with I/O commands for accessing the storage medium 10. The I/O command includes write and read commands. The I/O command is a command issued by the host 4 to the CSD 2.

[Host Command]

The host command is a command issued by the host 4 to the CSD 2. For the sake of convenience in the following explanations, it will be defined that the conventional CSD has the following command groups. The definitions given here are only for the purpose of convenience for use in the description of the specification. In practice, commands that is other than the command interface (IF) as described here and can achieve the same function are regarded as conventional functions.

[Common Matter]

The response from the CSD 2 to the host 4 for host commands shall be RET (status), except for commands with special descriptions. This response returns the status of “success” or “error”. The status “success” indicates that the processing for the host command was successful. The status “error” indicates that the processing for the host command has failed.

[Admin Command]

This is a group of commands for the host 4 to manage the CSD 2. There are commands for querying the capability of storage drive, querying the status, status management, etc. In this section, the following three commands are defined related to the acquisition of asynchronous notification information.

(1) Asynchronous Notification Setting Command H_CONF_ASYNC (Event_Flag)

This command is used to set a response to the asynchronous notification request command set by the host 4 when an asynchronous event of the CSD 2 specified by “event_flag” occurs. The asynchronous event is a process of independent of the request from the host 4.

(2) Asynchronous Notification Request Command H_REQ_ASYNC( )

This command is to request an asynchronous notification.

For this command, a response RET (status, event, log_id) is defined. The response RET (status, event, log_id) includes status of “success” or “error”, an asynchronous event type, and a log ID including detailed information.

(3) Log Getting Command H_GET_LOG (Log_Id, Hm_Addr)

This command is used to acquire the information of the log ID specified by “log_id” and written to the area of the HM 8 pointed to by an address “hm_addr”.

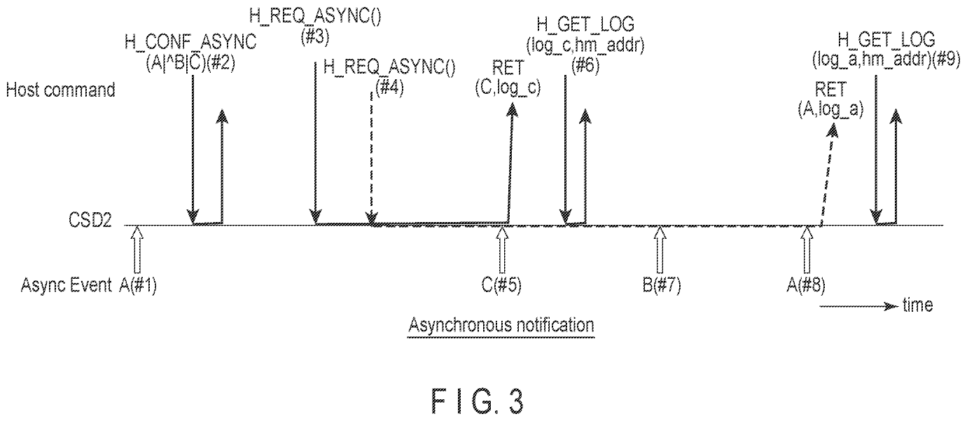

FIG. 3 is a diagram illustrating an example of the host 4 receiving an asynchronous notification from the CSD 2 and acquiring information.

In the CSD 2, an asynchronous event (Async Event) A occurs (#1). At this point, the CSD 2 does not make any special response.

The host 4 issues a command H_CONF_ASYNC( ) and sets a notification response to asynchronous events A and C, and no notification response to an asynchronous event B (#2). The CSD 2 returns a response RET( ) to this command.

The host 4 sends a command H_REQ_ASYNC( ) (#3).

The host 4 sends a command H_REQ_ASYNC( ) (#4).

An asynchronous event C occurs in the CSD 2 (#5). Since the asynchronous event C is set to have a notification response, the CSD 2 generates a response RET(C, log_c) to the command H_REQ_ASYNC( ) (#3) to the host 4.

The host 4 confirms the response RET (C, log_c), and issues a command H_GET_LOG( ) to obtain detailed information (#6). The CSD 2 shall return a response RET( ) to this command.

An asynchronous event B occurs in the CSD 2 (#7). Since the asynchronous event B is set to have no notification response, the CSD 2 does not take any special action.

An asynchronous event A occurs in the CSD 2 (#8). Since the asynchronous event A is set to have a notification response, the CSD 2 generates a response RET (A, log_a) to the command H_REQ_ASYNC( ) (#4) to the host 4.

The host 4 confirms the response RET (A, log_a), and issues the command H_GET_LOG( ) to obtain detailed information (#9). The CSD 2 returns the response RET( ) to this command.

[I/O Command]

This is a group of commands to access the storage medium 10. An access unit from the host 4 is a logical block (hereinafter referred to as LB). An access position is specified by a logical block address (hereinafter referred to as LBA).

The following two commands are defined.

(1) Write Command H_WRITE (Lba, Hm_Addr, Lbn)

This command is used to write data of an address “hm_addr” in the HM 8 to “lbn” LB areas consecutive from a logical block address “lba”.

(2) Read Command H_READ (Hm_Addr, Lba, Lbn)

This command is used to read data from “lbn” LB areas consecutive from a logical block address “lba” and to write the read data to an address “hm_addr” in the HM 8.

[Cs Command]

This is a group of commands that perform CS control. The following commands are defined.

(1) CPM TX Command H_TX (Cpm_Addr, Hm_Addr, Size)

This command is used to transfer (or copy) data for “size” from an address “hm_addr” in the HM 8 to an address “cpm_addr” in the CPM 20.

(2) CPM RX Command H_RX (Hm_Addr, Cpm_Addr, Size)

This command is used to transfer (or copy) data for “size” from an address “cpm_addr” in the CPM 20 to an address “hm_addr” in the HM 8.

(3) CPRG Load Command H_LOAD (Slot, Hm_Addr)

This command is used to download the CPRG 24 from an address “hm_addr” in the HM 8 to the slot 16 of a slot number “slot”.

(4) CPRG Execution Command H_EXEC (Slot, Cpm_Addr)

This command is used to execute the CPRG 24 stored in the slot 16 of a slot number “slot”. The H_EXEC( ) command specifies “cpm_addr” which is an address in the CPM 20 specified by the command to an argument “host_param” of the CPRG 24.

In response to this command, a command RET (status, host_ret) is defined. The command RET (status, host_ret) returns the status of “success” or “error”, and “host_ret” which is a return value of the CPRG 24.

[CPM Usage I/O Command]

This is a command to specify the CPM 20 as source and destination buffers for I/O commands accessing the storage medium 10.

(1) Write Command Using CPM: H_WRITE WC (Lba, Cpm_Addr, Lbn)

This command is used to write data of address “cpm_addr” in the CPM 20 to “lbn” LB areas consecutive from a logical block address “lba”.

(2) Read Command Using CPM: H_READ WC (Cpm_Addr, Lba, Lbn)

This command is used to read data from “lbn” LB areas consecutive from a logical block address “lba” to an address “cpm_addr” in the CPM 20.

Unlike the (1) CPRG execution command-driven startup method and the (2) I/O command-driven startup method for conventional CSDs, the CPRG startup method according to the embodiment is in association with events. Before explaining the CPRG start-up method according to the embodiment, an outline of the FTL and GC is described as a prerequisite.

[FTL, LUT, Zone, LUA, PUA]

The CSD 2 needs to respond to requests from the host 4 for random writes and random reads in logical block units. Furthermore, the CSD 2 has a built-in storage medium 10, and the characteristics of the storage medium 10 are restricted, like NAND flash memories, such that there are restrictions on the write order and erase unit. The CSD 2 needs to manage mapping between a logical address specified by the host 4 and a physical address in the storage medium 10. This mapping management between the logical addresses and physical addresses is called the FTL.

In this section, for the storage medium 10 with the following media characteristics, terms related to the FTL and GC will also be explained for the storage medium 10.
The writing unit is a unit.
The elimination unit is a zone.
The zone includes multiple units.
Writing to a unit must be done after erasing the zone and sequentially from the head unit of the zone.
Data reading can be performed randomly in units.

In accordance with this media characteristic, the FTL manages the mapping of logical addresses to physical addresses on a unit-by-unit basis.

The logical address of a unit referred to as a logical unit address (LUA).

The physical address of a unit is defined as a physical unit address (PUA). The PUA includes a combination of the zone number and the unit number in the zone.

A conversion table from LUA to PUA referred to as a look up table (LUT).

The unit size does not necessarily have to be the same as the write size (so-called page) for a single program command to a NAND flash memory. The unit size does not necessarily have to be the same as the size of the logical block specified by the host 4. The description of the unit is intended to mean that it can logically be handled as a unit for the address translation management by the FTL.

If the size of the so-called page or logical block differs from the unit size, it is intended that the adjustment be made outside the address translation mechanism by the FTL. For example, the following process is assumed.

(1) N consecutive logical blocks are treated as one unit, and the conversion from the logical block address to the LUA is performed by dividing one unit by N. A write request from the host 4 for a size less than the unit shall be processed by replacing the request with a read-modify-write for the unit. A read request for a size less than the unit shall be processed as a read for the unit, and a necessary part shall be cut out and returned to the host 4.

(2) Multiple consecutive units are grouped and treated as a single page, and writing to the flash memory is done by grouping together the write requests for units of the page size into a single program command.

Next, the FTL and GC are explained assuming that both the request from the host 4 and the access to the storage medium 10 are on the address space of the unit.

[Zone/Unit Status]

There are three statuses of the zone: all units are unwritten, at least one of the units is being written, and all units have been written. The statuses referred to as “free”, “dst”, and “used”, respectively.

To distinguish between the zone to be written by the host write and the zone to be written by the GC, the status of the zone to be written by the host write referred to as “host_dst”, and the status of the zone to be written by the GC referred to as “gc_dst”. The zone to be written includes a zone that has been selected as the write target of the host write and is about to be written, and a zone that has been selected as the write target, has already been written halfway, and is about to be written continuously. Furthermore, the status of the zone to be read by the GC referred to as “gc_src”.

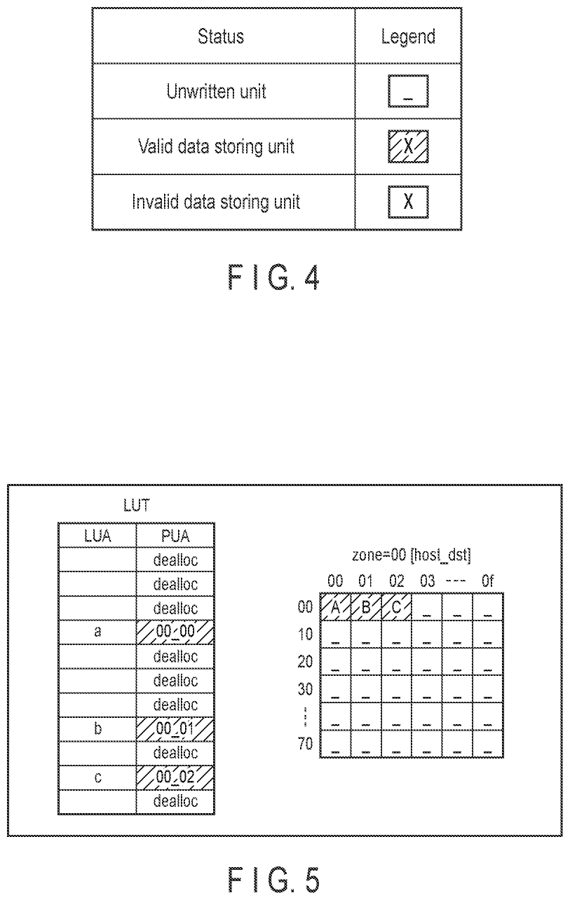

There are three statuses of the unit: unwritten, storing valid data, and storing invalid data. FIG. 4 is a diagram illustrating the status of a unit in the drawings of the specification. The valid data is data of the unit that the LUT points to. The invalid data is data other than valid data. The invalid data is also referred to as non-valid data. An example of the invalid data may be the management information of the FTL. In the explanation of the following drawings, as shown in FIG. 4, the unwritten unit in which neither the valid data nor invalid data is stored, the valid data storing unit, and the invalid data storing unit are distinguishable from each other.

[FTL and GC Operation]

The operation is explained based on the FTL having 0x80 units per zone and 0x30 zones. When a number is preceded by “0x”, it indicates that the number is in hexadecimal notation. In the notation of zone=XX, if a number is written in XX, then XX is a hexadecimal value, indicating that it is the XXth zone. In the notation of PUA=YY_ZZ, when a number is written in YY and ZZ, where YY and ZZ are both hexadecimal values, indicating that the unit is the ZZth unit of the YYth zone.

[Step 1: LUT Management by Host Write]

FIG. 5 is a diagram illustrating an example in which the FTL according to the embodiment manages the status of a zone by the LUT in Step 1. All zones are in the status of “free”, and data A, B, and C are written from the host 4 in the order of LUA=a, b, and c, The FTL selects one of the free zones (in this case, zone=00) as “dst”, and writes the data sequentially to “dst”.

In this way, the status of the zone to which a write request (host write) from the host 4 is written referred to as “host_dst”.

[Step 2: Generate Invalid Data Storing Unit]

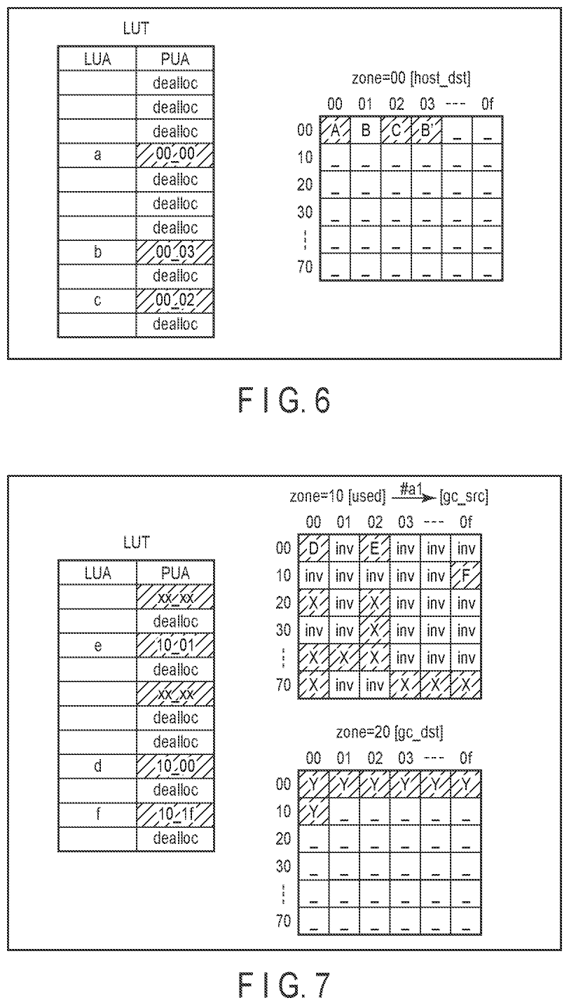

FIG. 6 is a diagram illustrating an example in which the FTL according to the embodiment manages the status of the zone by the LUT in step 2. After step 1, when there is a write of data B′ to LUA (=b), the FTL writes the value of data B′ to PUA (=00_03), and sets 00_03 to address “b” of the LUT. According thereto, reference to the unit of PUA (=00_01), and the status of the unit shifts to the invalid data storing unit.

[Step 3: GC]

If writing is continued, a situation will arise in which there are multiple zones of used that include the invalid data storing units. If the number of free zones falls below a certain number, it becomes impossible to provide a zone for “host_dst” when a write request is received from the host 4.

For this reason, the FTL collects only the data of valid data storing units from the used zones, writes the collected data to another zone, erases the used zone whose data has been written to the other zone, and changes the used zone to the free zone. This is the GC.

In the following, using an example wherein a zone (=20) is assigned to a zone in a status “gc_dst”, then a used zone (=10) is selected for “gc_src”, how the GC proceeds is explained.

[Step 3-1: GC Start]

FIG. 7 is a diagram illustrating an example of how the FTL according to the embodiment manages the status of the zone by the LUT at the time of GC start. FIG. 7 illustrates a status (#a1) where a zone (=20) is being written as “gc_dst” and a zone (=10) is selected as “gc_src” from the status where it was used. “Inv” indicates invalid data.

For a zone (=10), there are valid data storing units for PUAs (=10_00, 10_02, 10_1f . . . ) in a skipping manner. LUAs (=d, e, f) of the LUT refer to the PUA of the corresponding unit in a zone (=10). A zone (=20) has PUAs (=20_00 . . . 20_10) which are valid data storing units.

[Step 3-2: Data Movement for Valid Data Storing Units]

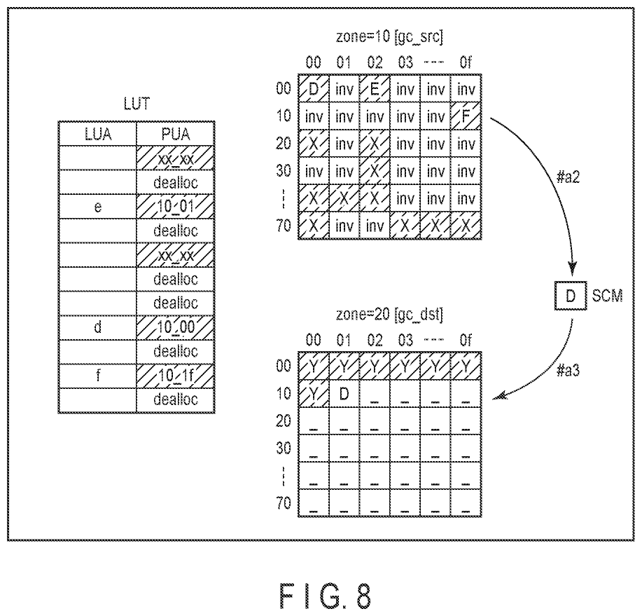

FIG. 8 is a diagram illustrating an example of how the FTL according to the embodiment manages the status of a zone during data movement of a valid data storing unit using the LUT.

The FTL reads data (value of data D of PUA=00_00) of the valid data storing unit (0x00th unit) from “gc_src” (zone=10) to the SCM 22 (#a2), and writes the data to the unit of “gc_dst” (zone=20) (PUA=20_11) (#a3).

At this time, a PUA of an LUA (=d) of the LUT is pointing to 10_00, and data at a PUA (=20_11) is still invalid data.

[Step 3-3: Update of LUT]

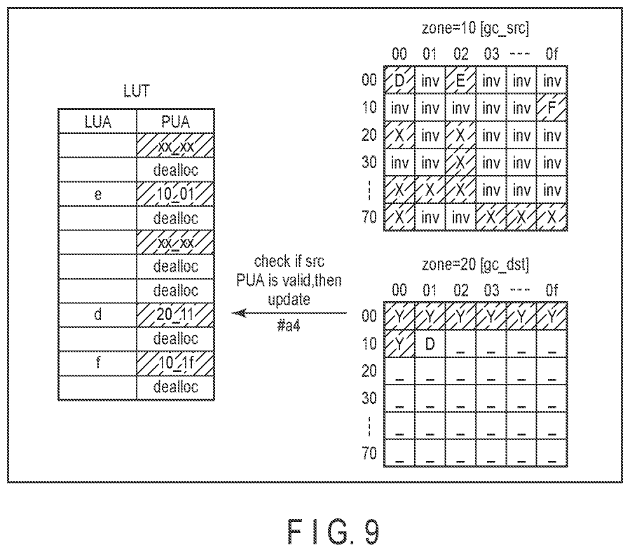

FIG. 9 is a diagram illustrating an example in which the FTL according to the embodiment manages the status of the zone using the LUT when updating the LUT.

The FTL checks whether the data of the copy source unit remains valid data (whether a PUA of an LUA (=d) is still 10_00). If the data of the copy source unit is valid data, the FTL copies the pointing address of an LUA (=d) to the copy destination address (PUA=20_11) (#a4).

Thus, the unit with a PUA (=10_00) becomes an invalid data storing unit, and the unit with a PUA (=20_11) becomes a valid data storing unit.

If the data of the copy source unit does not remain valid data, the FTL will assume that a host write has occurred at the address LUA (=d) during the execution of the step 3-2, and does not update the LUT. This results in exclusive processing of the write from the host 4 and the write by the GC.

[Step 3-4: Free of “gc_src”]

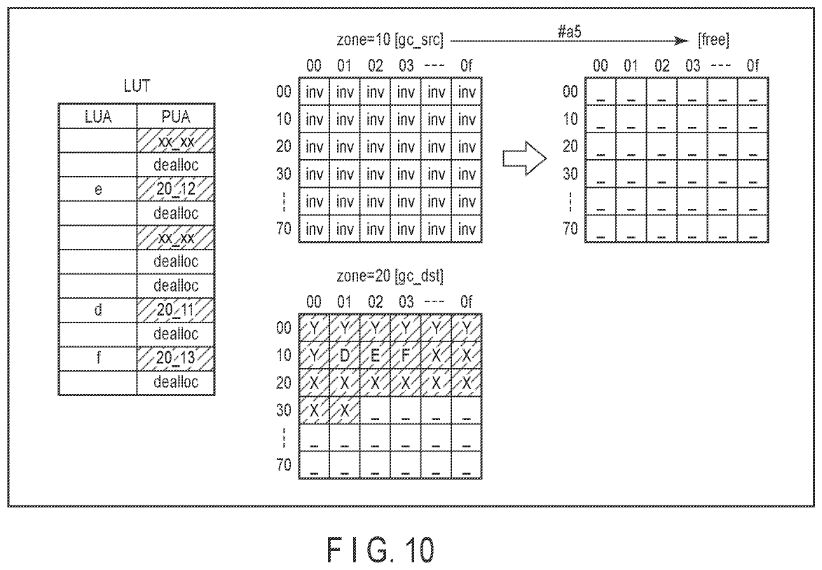

FIG. 10 is a diagram illustrating an example in which the FTL according to the embodiment manages the status of the zone by the LUT when “gc_src” is allocated as free.

The unit data is repeatedly moved and the LUT is repeatedly updated in the same way as in the steps 3-2 and 3-3. Thus, all units of “gc_src” become in the status of invalid data storing. When this status is reached, the data in a zone “gc_src” is erased or to be erasable, and the zone “gc_src” is allocated as the free zone (#a5).

[Purposes and Characteristics of GC]

The GC is performed for the following purposes.

(1) GC purpose. That is, acquisition of writable area by releasing invalid area.

(2) Refresh purpose. In accordance with the data retention characteristics of the storage medium 10, i.e., the reliability of data written in a zone deteriorates with time, data in a zone that was written for a long time is moved to another zone.

(3) Wear-leveling purpose. In accordance with the life degradation characteristics of storage medium 10 by the number of erasures, the product life is extended by leveling the number of erasures of all zones of the storage medium 10.

In the GC for (1) GC purpose, “gc_src” is selected from among the zones that include many invalid data storing units. This means that zones including a lot of hot data are selected as “gc_src” within a relatively short period of time.

On the other hand, for the purpose of (2) refreshing or (3) wear-leveling, “gc_src” is selected from the zone with the longest elapsed time after writing. This means that once the data is written by the host 4, even if it is cold data, it is moved by the GC at a certain frequency.

The start timing of the GC can be said to be indirectly related to the writing from the host 4, but directly, it is determined asynchronously from the host control within the CSD 2.

[Use Zone Based on Data Attribute]

It is known that there are techniques that can improve the performance of the FTL by using different write destination zones based on the attribute of the data to be written. The following are some examples.

By grouping data with high frequency of write into a zone and data with low frequency of write into another zone, it is possible to divide the zone into two zones, one where a lot of invalid data is included, and one where very little invalid data is included. Thus, the GC efficiency is increased to improve a write amplification factor (hereinafter referred to as WAF). The WAF is an index that indicates data of how many times the data supplied by the host 4 is written to the storage medium 10.

By using technologies to use different SLC/TLC/QLC, it is possible to distinguish between “zones with high capacity cost but high speed access” and “zones with low capacity cost but low speed access”. By allocating data with high frequency of read to the former and data with low frequency of read to the latter, the system as a whole can be optimized for “fast read response for frequently read data and large capacity storage for infrequently read data”.

The SLC/TLC/QLC is a write mode that determines how many bits of data are written to a memory cell of the storage medium 10. The storage medium 10 can perform write operations in multiple write modes that differ in how many bits of data are written per memory cell. A write mode in which one bit of data is written per memory cell is referred to as a single level cell (SLC) mode. A write mode in which three bits of data are written per memory cell is referred to as a triple level cell (TLC) mode. A write mode in which four bits of data are written per memory cell is referred to as a quad level cell (QLC) mode. There may be a write mode in which two bits of data are written per memory cell, called a multi-bit level cell (MLC).

[Overlap of Application and GC]

Some applications that use the storage drive, for example, perform the following processes.

There is a request that data stored in the storage drive is read, the read data is modified according to certain rules, and the modified data is written back to the storage drive. Although the write back does not need to be done quickly, a large amount of data may be written back.

If this is to be achieved with conventional technology, one of the following measures is taken.

(1) For non-CSD storage drives

Step 1: A host reads the data from the storage drive to the host memory.

Step 2: A host CPU performs a processing for the data in the host memory.

Step 3: The host writes back the data in the host memory to the storage drive.

(2) Conventional CSD

Step 1: A CSDC reads data from a storage medium to a CPM.

Step 2: A CPRG processes the data in the CPM.

Step 3: The CSDC writes the data back to the storage medium in the CPM.

On the other hand, the storage drive with an inside FTL performs a large amount of “data reading” and “data writing back” asynchronously with a host processing in a GC process.

For the reasons explained in [Purpose and characteristics of GC], the GC is performed with some frequency even if the written data is cold data.

That is, in both of the non-CSD storage drive and conventional CSD, a large amount of data read and a large amount of data write back are performed by the GC (that is, control by the storage drive) and the application (that is, control by the host) in duplicate. This leads to the following phenomena.

(1) It consumes the I/O bandwidth of the storage medium of the storage drive, leading to a decrease in the performance of application processing that should be performed.

(2) One of the characteristics of the storage medium is an upper limit of the number of times a zone can be erased. Therefore, as the number of erasures increases, the error rate increases, the time required to read and write the storage medium increases, and the capacity of the available storage medium decreases. Duplication of multiple writes will lead to a shorter life of the storage drive.

An example of a large amount of data read and a large amount of data write back being performed in duplicate includes the following.

### (Example 1) Data Conversion (Single Unit, Same LUA)

In some cases, data of a single unit size stored in an LUA of a storage medium is read out, modified according to a specific rule, and written back to the same LUA. The data conversion does not need to be done quickly, but it needs to be done in a large amount.

### (Example 2) Data Conversion (Multiple Units, Same LUA)

In some cases, data of multiple unit sizes stored in a group of LUAs in the storage medium is read out, data is modified according to a specific rule, and then written back to the same group of LUAs. Although the data conversion does not need to be done quickly, it needs to be done in large quantities.

### (Example 3) Compaction

When there is data stored in the storage medium that is no longer needed, the host application may perform a compaction to reduce the usage size of storage medium and improve performance. The compaction is similar to the GC. The difference is that the GC is performed by the FTL in the drive, while the compaction is performed by the host. When the compaction is performed, the LUA allocated to unnecessary data is released (deallocated). There is no need to rush the compaction.

### (Example 4) Change of PUA Address Order

A series of data that should be consecutive in the LUA may become non-consecutive in the PUA. This may happen when the host writes data in a random order, or when it writes sequential data to the LUA but also writes other data at the same time.

In consideration of storage performance, the PUA address order may be required to be modified to be consecutive even on a PUA basis.

### (Example 5) Data Storage Location Based on Data Attribute

By checking an attribute of data to be stored in the storage medium and determining the data storage location based on the attribute, the data may be located in a location suitable for the attribute in the storage medium. By placing the data in the appropriate location for the attribute, such as Hot/Cold, the performance of the storage medium may be improved.

### (Example 6) Data Movement

Data stored in an LUA of the storage medium may be required to be moved to another LUA.

### (Example 7) Data Conversion (Multiple Units, Non-Identical LUA)

Data of multiple unit sizes stored in a group of LUAs in the storage medium may be required to be read, modified according to a specific rule, and then written back to a different group of LUAs.

[Absence of a Mechanism to Link CPRG to Internal Storage Drive Event]

In addition to the GC, the storage drive manages various internal events. The internal events include a timer event, temperature threshold detection event, error occurrence event, and periodic data scan read processing event to maintain the reliability of data stored in the storage medium.

Conventional CSD does not have a mechanism to trigger the CPRG in association with such internal events, and thus have the following issues.

(1) Limited Degree of Freedom in the Timing of CPRG Startup

The CPRG can only be started when the CPRG start command from the host is executed, or when I/O commands such as read and write are executed. For users of a conventional CSD, the degree of freedom in designing the CPRG is low.

(2) A Large Overhead for Processing in Association with the Internal Event

Since the CPRG cannot perform an event-driven processing, it was necessary for the host-side application to perform an event-driven processing. For this purpose, the conventional CSD has to notify the host of the occurrence of an event, and the host has to perform the desired processing.

This incurs the overhead of notifying the host for each event occurrence, and consumes host resources by having the host perform the processing. Furthermore, if the processing in association with the event includes a status inquiry of the conventional CSD, additional communication overhead between the host and the CSD is incurred.

(3) Wasted Power Consumption

The conventional CSD may be set to a sleep mode for the purpose of reducing power consumption during a periods when there is no request from the host and no need for an internal event processing of the storage drive.

In order to start the CPRG in association with an internal event, the host sends a host command for starting the CPRG to the conventional CSD. If the conventional CSD is in the sleep mode at this transmission timing, the conventional CSD needs to perform the process of switching from the sleep mode to the normal mode for CPRG execution. Even if the content of the CPRG is not time-sensitive, the conventional CSD needs to energize its own related circuits to execute the CPRG, resulting in wasted power consumption.

This section describes the functions according to the embodiment, required for the CSD to link CPRG startup to internal events.

[1. Asynchronous Notification Setting Function]

[1.1. Asynchronous Notification Setting Function from the CPRG 24 to Host 4]

The CPRG 24 sends an asynchronous notification to the host 4 at a timing that is asynchronous to the processing of the host 4.

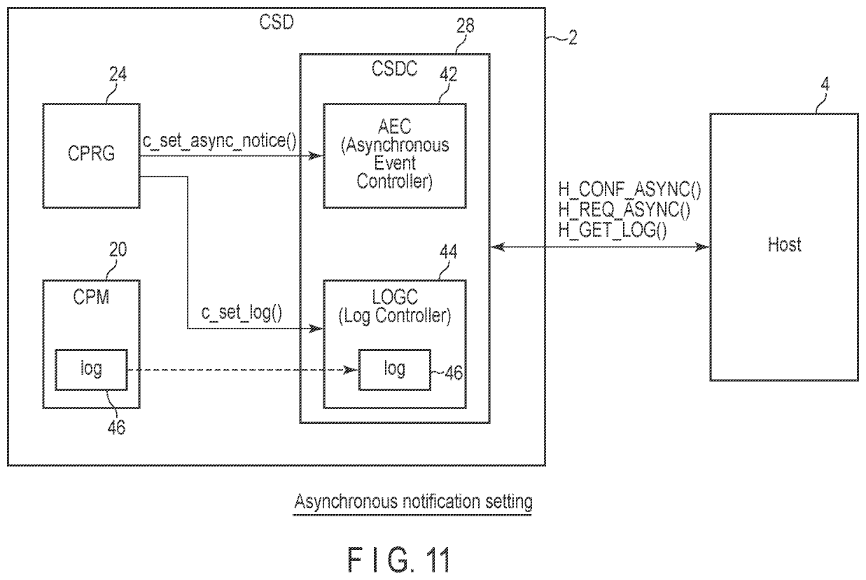

FIG. 11 is a block diagram illustrating an example of the asynchronous notification setting function in the CSD 2 according to the embodiment.

The CSDC 28 has functions for asynchronous notification and information acquisition to the host 4. The CSDC 28 includes, as an asynchronous notification function module, an asynchronous event controller (hereinafter referred to as AEC) 42 which is a function module to respond to a host command H_CONE_ASYNC( ) and H_REQ_ASYNC( ). The CSDC 28 includes, as an information acquisition function module, a log controller (hereinafter referred to as LOG C) 44 which is a functional module to respond to a host command H_GET_LOG( ).

Events which can be specified by the host 4 in the host command A_CONE_ASYNC( ) include a CPRG asynchronous notification.

“log_id” which can be specified by the host 4 in the host command H_GET_LOG includes a CPRG log.

The AEC 42 includes a CPRG helper function c_set_async_notice( ) to set the CPRG asynchronous notification from the CPRG 24.

The LOG C 44 includes is a CPRG helper function c_set_log( ) to set the CPRG log from the CPRG 24.

The CPRG helper function c_set_log( ) can specify “cpm_addr” and “size” by arguments such that the CPRG 24 can intake the log 46 created by the CPRG 24 in the CPM 20 into the LOG C 44.

Note that, as a simple example, an event that can be specified by the host command A_CONE_ASYNC( ) is one type of the CPRG asynchronous notification and the log_id that can be specified by the host command H_GET_LOG( ) is one type of the CPRG log.

As an extension of the above, by switching events and log_ids depending on a CPRG startup factor, multiple types of events and log ids may be specified.

Even with the conventional CSD, the host command A_CONE_ASYNC( ), H_REQ_ASYNC( ), and H_GET_LOG( ) may be defined. In that case, as the host command interfaces, the host commands A_CONE_ASYNC( ), H_REQ_ASYNC( ), and H_GET_LOG( ) may be defined using the same command as these conventional host commands distinguished by arguments, or as new different commands.

According to [1. Asynchronous notification setting function], the CPRG 24 can send the asynchronous notification to the host 4.

[2. Internal Event-Driven CPRG Startup Function (Basic Type)]

The function of the CSD 2 to start the CPRG 24 in association with an internal event is explained.

Internal events are any events that occur asynchronously to the control from the host 4, including notifications from a timer in the CSD 2, notifications from a temperature sensor in the CSD 2, notifications when the storage medium 10 usage threshold is reached in the CSD 2, etc. In this section, as a basic type, a configuration with one type of event and one target slot (CPRG) is described.

[2.1. Internal Event-Driven CPRG Startup Function]

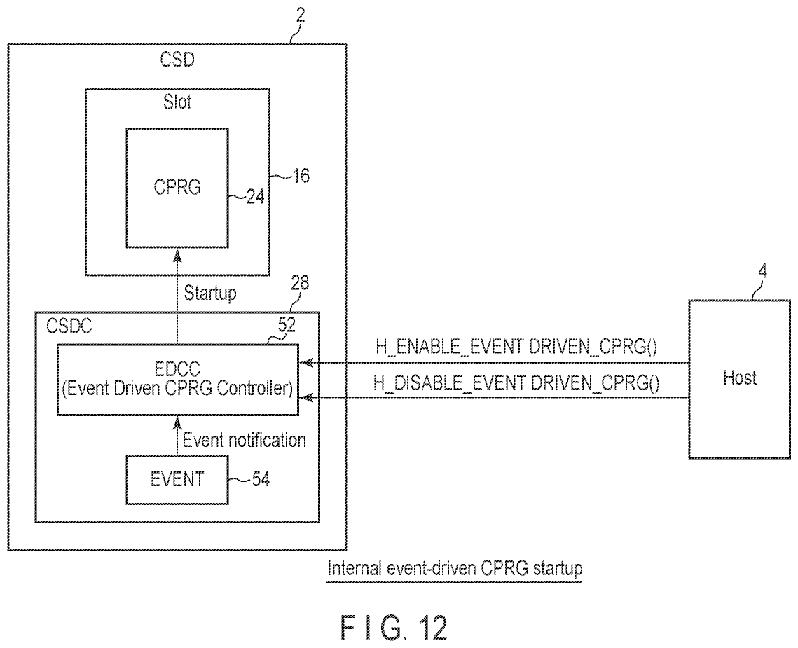

FIG. 12 is a block diagram illustrating an example of an internal event-driven startup function in the CSD 2 according to the embodiment.

The CSDC 28 includes an event-driven CPRG Controller (EDCC) 52 configured to start the CPRG 24 in association with an internal event 54.

The EDCC 52 includes the following functions.

(1) Function corresponding to a setting command from the host 4 to enable or disable the internal event-driven CPRG startup

The host 4 includes an internal event-driven function enable command H_ENABLE_EVENT_DRIVEN_CPRG( ) to enable a function of starting the CPRG 24 in association with an internal event.

The host 4 includes an internal event-driven function disable command H_DISABLE_EVENT_DRIVEN_CPRG( ) to disable the function of starting the CPRG 24 in association with the internal event.

(2) Function to start the CPRG 24 upon receipt of an event occurrence notification from an internal event generator of the CSD 2 (when the internal event-driven function is enable)

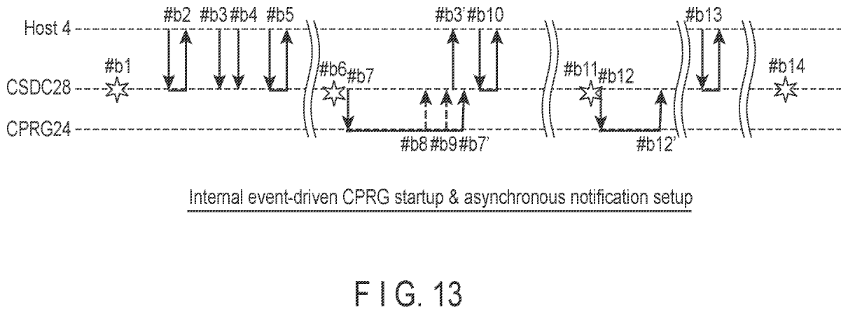

FIG. 13 is a timing diagram illustrating an example of control among the host 4, CSDC 28, and CPRG 24 when [1. Internal event-driven CPRG startup function (basic type)] and [1.1. Asynchronous notification setup function from the CPRG 24 to host 4] according to the embodiment are combined.

An internal event occurs in the CSDC 28 (#b1). At this point, the internal event-driven function is disabled, and no special processing is performed.

Although it is asynchronous with the process of #b1, the host 4 issues the command H_CONF_ASYNC( ) to set the CPRG asynchronous notification to the CSDC 28 (#b2).

The host 4 issues the command H_REQ_ASYNC( ) to the CSDC 28 (#b3, #b4).

The host 4 issues the command H_ENABLE_EVENT_DRIVEN_CPRG( ) to enable the internal event-driven function to the CSDC 28 (#b5).

Although it is asynchronous to the process of #b5, an internal event occurs in the CSDC 28 (#b6). At this point, the internal event-driven function is enabled, and thus, the process of #b7 is performed immediately.

The CSDC 28 starts the CPRG 24 (#b7). Supposing that the CPRG 24 performs an operational processing and wants to notify the host 4 of something. At that time, processes in #b8 and #b9 are performed.

The CPRG 24 will set a log wanted to transmit to the host 4 using the command c_set_log( ) in the CSDC 28 (#b8).

The CPRG 24 will set the asynchronous notification requirement in the CSDC 28 using the command c_set_async_notice( ) notifying the CPRG asynchronous notification to the host 4 (#b9).

With the setting of #b9, the CSDC 28 returns a response (asynchronous notification) to the host 4 in response to the command H_REQ_ASYNC( ) in #b3 (#b3′). The CPRG 24 terminates (#b7′).

The host 4 receives the asynchronous notification from the CPRG 24 and, if necessary, issues the host command H_GET_LOG( ) to obtain the detailed log (#b10).

Although asynchronous to the process of #b10, an internal event occurs in the CSDC 28 (#b11). At this point, the internal event-driven function is enabled, and thus, the process of #b12 is performed immediately.

The CSDC 28 starts the CPRG 24 (#b12). Supposing that the CPRG 24 performs a computational operation and there is nothing that it wants to notify to the host 4, the CPRG 24 terminates (#b12′).

Although asynchronous with the process of #b12, the host 4 sends the command H DISABLE COMMAND to disable the internal event-driven function to the CSDC 28 (#b13).

Although asynchronous to the process of #b13, an internal event occurs in the CSDC 28 (#b14). At this point, the internal event-driven function is disabled, so no special processing is performed.

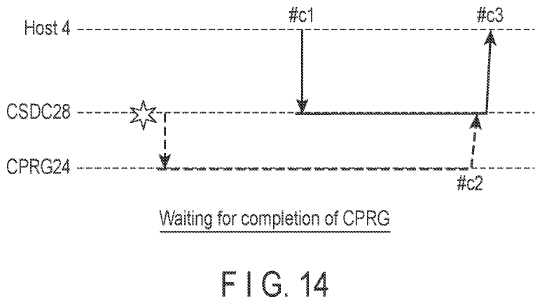

FIG. 14 is a timing diagram illustrating another example of control among the host 4, CSDC 28, and CPRG 24 according to the embodiment.

In the control example in FIG. 13, when the internal event-driven function disable command H_DISABLE_EVENT_DRIVEN_DRIVEN_CPRG( ) is issued during the execution of the CPRG 24, as shown in FIG. 14, a response may be returned after waiting for the completion of the execution of the CPRG 24.

During the execution of the CPRG 24, the host 4 issues the command H_DISABLE_EVENT_DRIVEN_CPRG( ) (#c1).

The CSDC 28 will wait for the end of the execution of the CPRG 24. When the execution of the CPRG 24 is ended (#c2), the CSDC 28 returns a response of the command H_DISABLE_EVENT_DRIVEN_CPRG( ) to the host 4 (#c3).

Thus, the host 4 can recognize that the execution of the CPRG 24 is completely ended.

[2.2. Internal Event-Driven CPRG Startup Function Supporting Multi-Instance]

The EDCC 52 of the CSDC 28 may include an internal event-driven CPRG startup function supporting multiple instances. The internal event-driven CPRG startup function supporting multiple instances is a function that, when a next internal event occurs while the CPRG 24 is executed, if the resources of the CSE 18 are free, the next CPRG 24 is started.

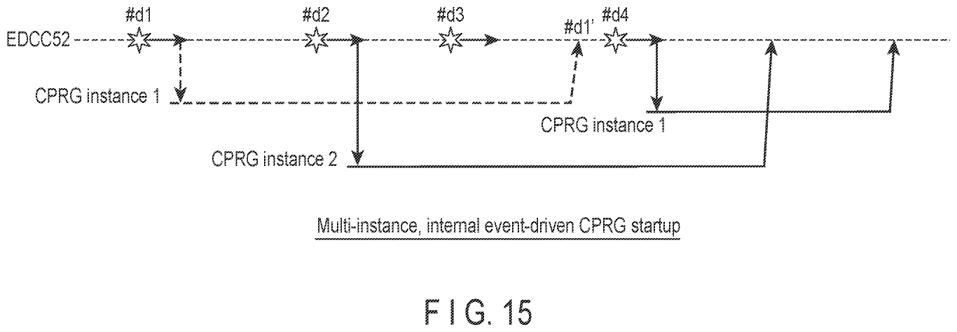

FIG. 15 is a timing diagram illustrating an example of the multi-instance support and internal event-driven CPRG startup function in the CSD 2 according to the embodiment. FIG. 15 illustrates the multi-instance support and internal event-driven CPRG startup when the number of CSEs 18 is two.

An internal event occurs in the CSDC 28 (#d1). At this point, the number of instances of the CPRG 24 is zero. Since there is a CSE 18 available, the CSDC 28 starts the CPRG 24 and creates CPRG instance 1. The number of instances is 1.

An internal event occurs in the CSDC 28 (#d2). At this point, the number of instances of the CPRG 24 is 1. Since there is a CSE 18 available, the CSDC 28 starts the CPRG 24 and creates CPRG instance 2. The number of instances is 2.

An internal event occurs in the CSDC 28 (#d3). At this point, the number of instances of the CPRG 24 is 2. Since there is no CSE 18 available, the CSDC 28 does not start the CPRG 24.

The process of the CPRG instance 1, which was started in the process of #1, is ended (#d1′). At this point, the number of instances of the CSDC 28 becomes 1.

An internal event occurs in the CSDC 28 (#d4). At this point, the number of instances of the CPRG 24 is 1. Since there is a CSE 18 available, the CSDC 28 starts the CPRG 24 and creates CPRG instance 1.

FIG. 15 is a simple example of a method that simply ignores an event if there are no resources available when it occurs.

The EDCC 52 may store information indicative of the event occurred, and delay the startup of the CPRG 24 until the time when the resources of the CSE 18 become available.

It is assumed that the CPRG 24 uses the resources of the CPM 20, etc., when performing a computational operation.

When multiple CPRG instances are started at the same time, in order to know which resource should be used by each of the CPRG instances, the EDCC 52 may set CSD instance number (a number to uniquely identify CSD instance) to the argument “csd_param” of the CPRG 24.

Furthermore, there may be a case where the host 4 wants to start only a smaller number of instances than the number of CSE 18 at the same time due to the resource allocation convenience of the CPM 20. To deal with this matter, a function to set an upper limit on the number of simultaneous starts of the internal event-driven CPRG 24 may be provided.

According to [2.2. Internal event-driven CPRG startup function supporting multi-instance], when an internal event occurred during the execution of a CPRG instance, if there is room in the CSE 18 resource, the next CPRG 24 is started.

Note that, when the next internal event occurred during the execution of the maximum number of CPRG instances, the occurrence of the internal event may be stored, and the CPRG 24 may be started when the CPRG instance currently being executed is ended.

When the CPRG 24 is started, the CPRG 24 may transmit the CSD parameter “csd_param” including the CSD instance number, to the host 4.

The host 4 may issue an internal event-driven CPRG concurrent execution upper limit setting command H_SET_MAX_EVENT_DRIVEN_CPRG (num) to set the upper limit of the concurrently executable internal event-driven CPRG instances.

[2.3. Internal Event-Driven CPRG Startup Function with Host Parameter Setting Function]

The EDCC 52 of the CSDC 28 includes a function that the host parameter to be transmitted to the CPRG 24 can be set by the host 4 when the CPRG 24 is started.

In the conventional CSD, the CPRG is started synchronously with the CPRG execution command and I/O command issued by the host. In this case, the host could set host parameters as the arguments of the CPRG startup command.

In the case of the CSD according to the embodiment, since the CPRG instance is created asynchronously with the host command, it is necessary to transmit the host parameters to the CSD 2 separately. Some methods of transmitting the host parameters are explained.

(1) Fixed Host Parameter Method

This is the simplest host parameter setting method. In this method, “host_param” is added to the internal event-driven function enable command. The same value is set to the host parameter of all instances started during the enable of the function.

An internal event-driven function enable command (host_param extension) H_ENABLE_EVENT_DRIVEN_CPRG (host_param) enables the internal event-driven function, and transmits the “host_param” to the CSD 2 as an argument when the CPRG 24 is started.

(2) Host Parameter Setting Command Method

This method provides a host parameter setting command. In this method, the value of the host parameter of the CPRG instance can be modified dynamically while the internal event-driven function is enabled.

An internal event-driven function host parameter setting command H_SET_EVENT_DRIVEN_CPRG_HOST_PARAM (host_param) sets the host parameters of the CPRG instance to be started by the internal event.

(3) Host Parameter Setting Command Method for Each Instance Number

This method provides a command that can be used to set host parameters for each CPRG instance number. In this method, the value of the host parameter can be modified dynamically for each CPRG instance while the internal event-driven function is enabled.

An internal event-driven function host parameter setting command (extended for each instance number) H_SET_EVENT_DRIVEN_CPRG_HOST_PARAM (instance_no, host_param) sets the host parameters of the CPRG instance started by the internal event specified by an instance number “instance no”.

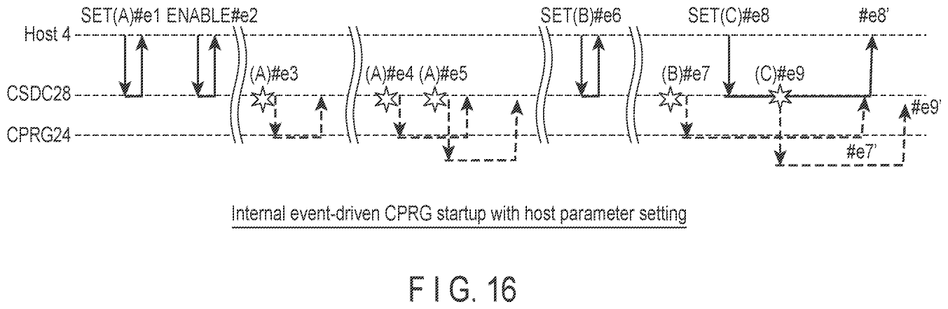

FIG. 16 is a timing diagram illustrating an example of host parameter setting by the host parameter setting command method in the CSD 2 according to the embodiment.

The host 4 issues a command H_SET_EVENT_DRIVEN_CPRG_HOST_PARAM (A) to the CSDC 28, and sets “A” to the host parameter of the CPRG 24 started by the internal event (#e1). The host parameter “A” may be a numeric value, a character string, or a more complex data structure.

The host 4 issues a command H_SET_ENABLE_EVENT_DRIVEN_CPRG( ) to the CSDC 28 to enable the internal event-driven function (#e2).

An internal event occurs in the CSDS 28 (#e3), which is asynchronous to the process of #e2. The CSDC 28 starts the CPRG 24. At this time, the CSDC 28 sets “A” to the argument “host_param” of the started CPRG 24 instance.

Although asynchronous to the process of #e3, an internal event occurs in the CSDS 28 (#e4). The CSDC 28 starts the CPRG 24. At this time, the CSDC 28 sets “A” to the argument “host_param” of the started CPRG 24 instance.

An internal event occurs in the CSDS 28 (#e5). The CSDC 28 starts the CPRG 24. At this time, the CSDC 28 sets “A” to the argument “host_param” of the started CPRG 24 instance.

Although the process is asynchronous with the process of #e5, the host 4 issues a command H_SET_EVENT_DRIVEN_CPRG_HOST_PARAM (B) to the CSDC 28, and sets “B” to the host parameter of the CPRG 24 started by the internal event (#e6).

Although asynchronous to the process of #e6, an internal event occurs in the CSDS 28 (#e7). The CSDC 28 starts the CPRG 24. At this time, the CSDC 28 sets “B” to the argument “host_param” of the started CPRG 24 instance.

During the execution of the CPRG instance created in the process of #e7, the host 4 issues a command H_SET_EVENT_DRIVEN_CPRG_HOST_PARAM (C) to the CSDC 28, and sets “C” to the host parameter of the CPRG (#e8). Before returning a response to the host 4 (#e8′), the CSDC 28 waits for the end of CPRG instance currently being executed with the host parameter “host_param (=B)” before the switchover.

While waiting for the end of the CPRG instance, an internal event occurs in the CSDS 28 (#e9). The CSDC 28 starts the CPRG 24. At this time, the CSDC 28 sets “C” to the argument “host_param”.

The CPRG instance being executed with the argument “host_param (=B)” is ended (#e7′).

After the process of #e7′, the CSDC 28 returns a command H_SET_EVENT_DRIVEN_CPRG_HOST_PARAM( ) to the host 4 (#e8′).

If there is a CPRG instance that is being executed with the previous parameter in issuing the command H_SET_EVENT_DRIVEN_CPRG_HOST_PARAM( ) waiting for the end of the CPRG instance may be omitted.

[2.4. Internal Event-Driven CPRG Startup Function with Configuration Function]

The EDCC 52 of the CSDC 28 includes a function that the configuration of the internal event-driven function can be set by the host 4.

For example, the EDCC 52 includes an interface for configuring startup conditions such as “Start CPRG only when the temperature exceeds the threshold” for an event “temperature change detection”, and “Start CPRG when the interval time has elapsed since the event detection” for a timer event. Some configuration Setting Methods are Shown Below.

(1) Fixed configuration method This is the simplest configuration setting method.

In this method, a configuration value “configuration” is added to the internal event-driven function enable command. The same configuration value is applied while enabling of the function.

An internal event-driven function enable command (configuration expansion) H_ENABLE_EVENT_DRIVEN_CPRG(configuration) specifies “configuration”, and enables the internal event-driven function.

(2) Configuration Setting Command Method

This method provides a configuration setting command. In this method, the configuration value can be changed dynamically while the internal event-driven function is enabled.

Internal event-driven function configuration setting command H_SET_EVENT_DRIVEN_CPRG_CONFIG (configuration) sets the configuration of the internal event-driven function.

For details on the timing of configuration settings in this method, refer to the timing explanation (FIG. 16) in (2) Host parameter setting command method in [2.3. Internal event-driven CPRG startup function with host parameter setting function], and the detailed description thereof is omitted here.

According to [2. Internal event-driven CPRG startup function], it is possible to increase the degree of design flexibility of a startup timing of the CPRG 24 for users of the CSD 2. A computational operation in association with the internal event can be performed by the CPRG 24 instead of by the host 4, and thus it is possible to reduce the amount of communication between the CSD 2 and the host 4. It is possible to obtain the effect of reducing the amount of power consumption by delaying a non-time-sensitive CPRG startup until the wake-up timing of the CSD 2 that accompanies the occurrence of internal event processing. It is possible to start multiple CPRG instances simultaneously in association with the internal events. The host 4 can set the parameter to the CPRG 24 in association with the internal event at the timing desired of the host 4. The host 4 can set the configuration setting of the CPRG startup in association with the internal event at the desired timing of the host 4.

[3. Internal Event-Driven CPRG Startup Function (Multi-Event, Multi-Slot)]

The example described in [2. Internal event-driven CPRG startup function (basic type)] above includes one type of event and one target slot. The example described hereinafter includes multiple slots and event types.

[3.1. Single Event, Multi-Slot, Single Connection, Internal Event-Driven CPRG Startup Function]

This function is an internal event-driven CPRG startup function with one internal event type as the source of CPRG startup, multiple slots to be started, and one connectable slot per event.

This function is realized by extending the host command described in [2. Internal event-driven CPRG startup function (basic type)].

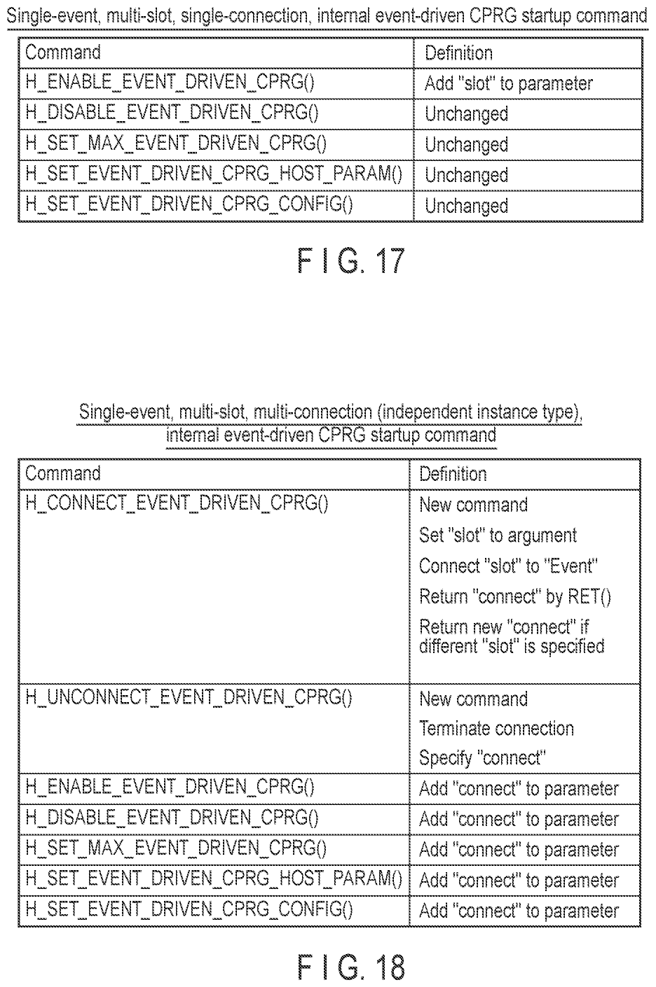

FIG. 17 is a diagram illustrating an example of host commands where the CSD 2 achieves the single-event, multi-slot, single-connection, internal event-driven CPRG startup function.

A host command H_ENABLE_EVENT_DRIVEN_CPRG( ) will have “slot” added to its parameters.

Host commands H_DISABLE_EVENT_DRIVEN_CPRG( ), H_SET_MAX_EVENT_DRIVEN_CPRG( ), H_SET_EVENT_DRIVEN_CPRG_HOST_PARAM( ), and H_SET_EVENT_DRIVEN_CPRG_CONFIG( ) remain unchanged.

[3.2. Single-Event, Multi-Slot, Multi-Connection, Internal Event-Driven CPRG Startup Function]

This function is an internal event-driven CPRG startup function with one internal event type as the source of CPRG startup, multiple slots to be started, and multiple slots that can be connected per event.

There are two main types of methods to achieve this function.

(1) Method in which multiple different CPRG instances are started for each specified slot for a single event (independent instance type)

(2) Method in which one CPRG instance is started and CPRGs 24 of the specified slots are executed sequentially for one event (same instance type)

As mentioned earlier, an instance refers to a memory area and its contents that are expanded in a memory when a program is executed, the memory area storing the program's arguments and intermediate status information during program execution. When a program “A” is executed, one instance exists until the program “A” is ended. When the program “A” is executed again while the program “A” is executing, two instances exist while the two executions are in parallel.

Therefore, the independent instance type is a method in which one instance is created for each CPRG stored in each slot. For example, a CPRG_A is stored in a slot α, a CPRG_B is stored in a slot β, and one event has two connections. If the slot α is specified for one connection, and the slot β is specified for the other connection, then when the event occurs, the CSDC 28 starts two instances, an instance 1 executing the CPRG_A and an instance 2 executing the CPRG_B in parallel. That is, the CPRG_A and CPRG_B are executed in parallel.

The same instance type is a method in which multiple CPRGs stored in the specified multiple slots are executed in order in a single instance. For example, the CPRG_A is stored in the slot α, and the CPRG_B is stored in the slot β, and one event has one connection. A single list with the slot α and slot β is set to an argument for one connection. The CPRG_A and CPRG_B are connected to the event. When the event occurs, the CSDC 28 creates the instance 1, and the CPRG_A is executed on the instance 1. When the execution of the CPRG_A is ended, the CPRG_B is executed.

[3.2.1. Single-Event, Multi-Slot, Multi-Connection (Independent Instance Type), Internal Event-Driven Startup Function]

This function is realized by extending the host command of [2. Internal event-driven CPRG startup function (basic type)].

FIG. 18 is a diagram illustrating an example of host commands in which the CSD 2 realizes the single-event, multi-slot, multi-connection (independent instance type), internal event-driven CPRG startup function.

A host command H_CONNECT_EVENT_DRIVEN_CPRG( ) is newly defined. The slot number is set to the argument of this command. This command sets the CSD 2, when an internal event occurs, to connect the internal event to the slots 16 specified by a slot number, that is, to start the CPRG 24. The CSD 2 returns the connect number to the host 4 in a response RET( ). If a slot number different from the connected slot number is specified by the argument, the CSD 2 returns the new connect number to the host 4 in the response RET( ). The connect number is a number assigned to uniquely identify the connection (connect) between the internal event and the slot. In the case of a single event, the connect number can be omitted, but it is returned to the host 4 in order to align the command structure with that of a multi-event.

A host command H_UNCONNECT_EVENT_DRIVEN_CPRG( ) is newly defined. The connect number is set to the argument of this command. This command sets the CSD 2 to terminate the connection of the internal event with the slots 16 specified by the connect number when an internal event occurs.

The host commands H_ENABLE_EVENT_DRIVEN_CPRG( ), H_DISABLE_EVENT_DRIVEN_CPRG( ), H_SET_MAX_EVENT_DRIVEN_CPRG( ), H_SET_EVENT_DRIVEN_CPRG_HOST_PARAM( ), and H_SET_EVENT_DRIVEN_CPRG_CONFIG( ) have the connect number added to their parameters.

[3.2.2. Single Event, Multi-Slot, Multi-Connection (Same Instance Type), Internal Event-Driven CPRG Startup Function]

This function is realized by extending the host command described in [2. Internal event-driven CPRG startup function (basic type)].

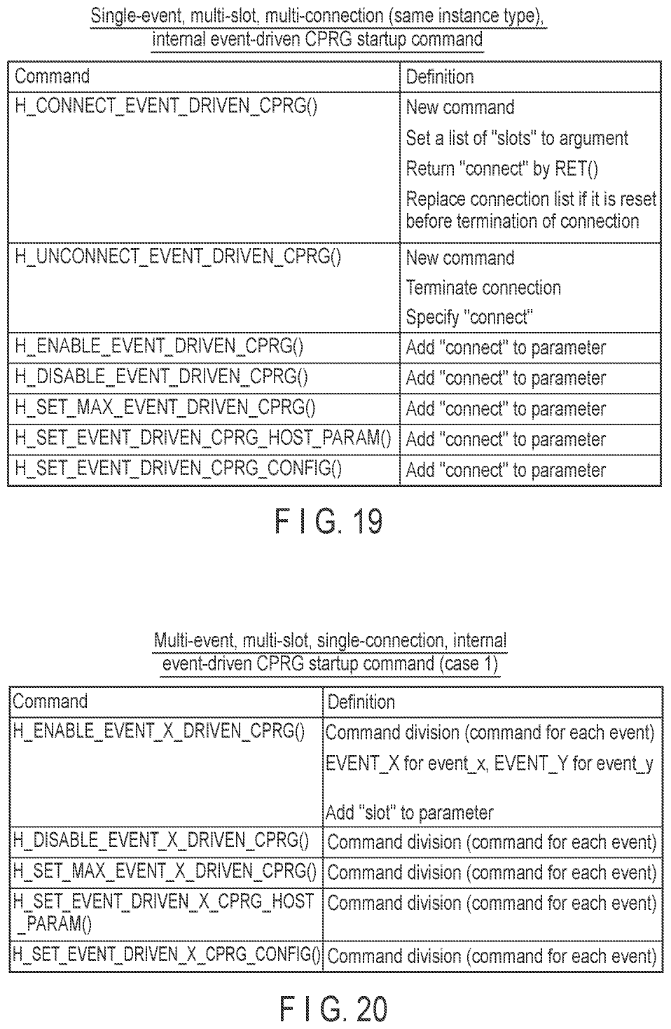

FIG. 19 is a diagram illustrating an example of host commands in which the CSD 2 realizes the single-event, multi-slot, multi-connection (same instance type), internal event-driven CPRG startup function.

A host command H_CONNECT_EVENT_DRIVEN_CPRG( ) is newly defined. A list of slot numbers is set to the arguments of this command. This command sets the CSD 2 to connect an internal event to multiple slots 16 specified in the list of slot numbers when the internal event occurs. The CSD 2 returns the connect number to the host 4 in the response RET( ) of this command. For example, if three CPRGs with slot=1, slot=3, and slot=8 are connected to one event, one connect number is returned to the host 4. By specifying the connect number and issuing the host command H_UNCONNECT_EVENT_DRIVEN_CPRG( ), the connections of all three CPRGs are simultaneously ended. If the connection is reestablished before it is ended, the CSD 2 returns a list of new connect number to the host 4 in the response RET( ),

An example of a connect number is described below. For example, the host command

H_CONNECT_EVENT_DRIVEN_CPRG is called three times as follows.

H_CONNECT_EVENT_DRIVEN_CPRG (event=event a, slot=1)

H_CONNECT_EVENT_DRIVEN_CPRG (event=event b, slot=2)

H_CONNECT_EVENT_DRIVEN_CPRG (event=event c, slot=1)

The connect number is a number to distinguish the connection made by each host command. “1” is returned as the first connect number, “2” is returned as the second connect number, and “3” is returned as the third connect number.

In this example, “slot=1” is set for “event a”, and “slot=1” is set for “event c”. The CPRG with the same slot (=1) is connected to multiple events. Therefore, if the first connection should be ended, the connection to be ended cannot be specified by using the slot number, but must be specified by using the connect number.

A host command H_UNCONNECT_EVENT_DRIVEN_CPRG( ) is newly defined. The connect number is set to the argument of this command. This command sets the CSD 2 to terminate the connection of the internal event to the slot 16 specified by the connect number when the internal event occurs.

The host commands H_ENABLE_EVENT_DRIVEN_CPRG( ), H_DISABLE_EVENT_DRIVEN_CPRG( ), H_SET_MAX_EVENT_DRIVEN_CPRG( ), H_SET_EVENT_DRIVEN_CPRG_HOST_PARAM( ), and H_SET_EVENT_DRIVEN_CPRG_CONFIG( ) have the connect number added to their parameters.

[3.3. Multi-Event, Multi-Slot, Single-Connection, Internal Event-Driven CPRG Startup Function]

This function is an internal event-driven CPRG startup function with multiple types of internal events as the source of CPRG startup, multiple slots for startup, and a single number of slots that can be connected per event.

This function is realized by extending the host command described in [2. Internal event-driven CPRG startup function (basic type)].

FIG. 20 is a diagram illustrating an example of host commands to realize the multi-event, multi-slot, single-connection, internal event-driven CPRG startup function by the CSD 2.

The host commands H_ENABLE_EVENT_DRIVEN_CPRG( ), H_DISABLE_EVENT_DRIVEN_CPRG( ), H_SET_MAX_EVENT_DRIVEN_CPRG( ), H_SET_EVENT_DRIVEN_CPRG_HOST_PARAM( ), and H_SET_EVENT_DRIVEN_CPRG_CONFIG( ) are extended to host commands

H_ENABLE_EVENT_X_DRIVEN_CPRG( ), H_DISABLE_EVENT_X_DRIVEN_CPRG( ), H_SET_MAX_EVENT_X_DRIVEN_CPRG( ), H_SET_EVENT_X_DRIVEN_CPRG_HOST_PARAM( ), and H_SET_EVENT_X_DRIVEN_CPRG_CONFIG( ), respectively.

The host command H_ENABLE_EVENT_X_DRIVEN_CPRG( ) is provided for each event. For example, EVENT_X is set to event_x, and EVENT_Y is set to event_y, and “slot” is added to the parameter.

The host commands H_DISABLE_EVENT_X_DRIVEN_CPRG( ), H_SET_MAX_EVENT_X_DRIVEN_CPRG( ), H_SET_EVENT_X_DRIVEN_CPRG_HOST_PARAM( ), and H_SET_EVENT_X_DRIVEN_CPRG_CONFIG( ) are similarly provided for each event.

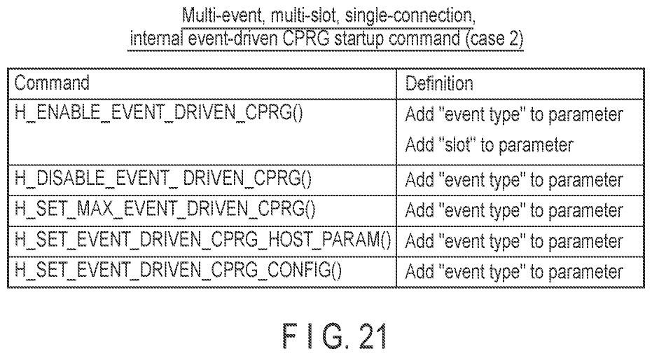

FIG. 21 is a diagram illustrating another example of host commands to realize the multi-event, multi-slot, single-connection, internal event-driven CPRG startup function by the CSD 2.

The host command H_ENABLE_EVENT_DRIVEN_CPRG( ) is extended to add an “event type” and “slot” to its parameters.

The host commands H_DISABLE_EVENT_DRIVEN_CPRG( ), H_SET_MAX_EVENT_DRIVEN_CPRG( ), H_SET_EVENT_DRIVEN_CPRG_HOST_PARAM( ), and H_SET_EVENT_DRIVEN_CPRG_CONFIG( ) are extended to add the “event type” to their parameters.

[3.4. Multi-Event, Multi-Slot, Multi-Connection, and Internal Event-Driven CPRG Startup Function]

This function is achieved by a combination of [3.2. Single-event, multi-slot, multi-connection, internal event-driven CPRG startup function] and [3.3. Multi-event, multi-slot, single-connection, internal event-driven CPRG startup function].

Hereinafter, a case of [3.4. Multi-event, multi-slot, multi-connection, and internal event-driven CPRG startup function] where [3.2.1. Single-event, multi-slot, multi-connection (independent instance type), internal event-driven CPRG startup function] is adopted as [3.2. Single-event, multi-slot, multi-connection, internal event-driven CPRG startup function] is described.

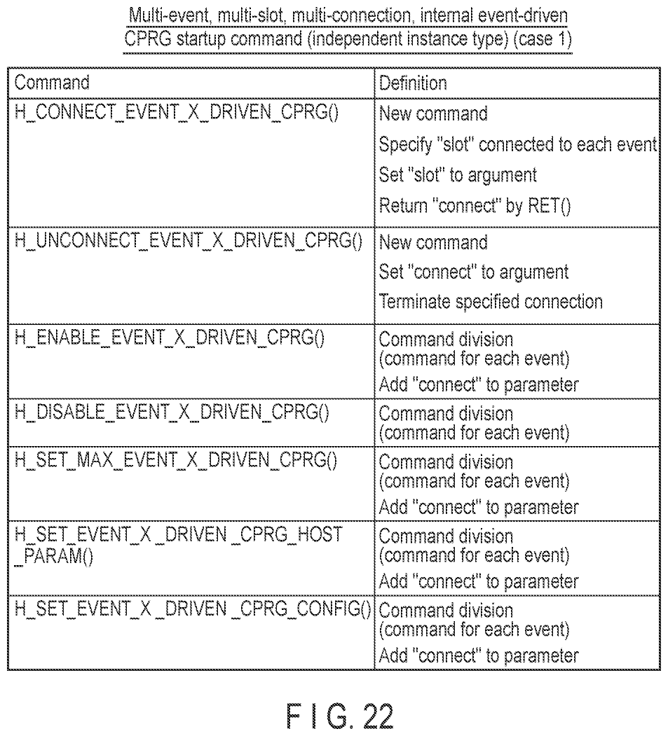

FIG. 22 is a diagram illustrating an example of host commands to realize the multi-event, multi-slot, multi-connection, internal event-driven CPRG startup function by the CSD 2.

Host_commands_H_CONNECT_EVENT_X_DRIVEN_CPRG( ) and H_UNCONNECT_EVENT_X_DRIVEN_CPRG( ) are newly defined.

Slot numbers are set to the argument of the host command H_CONNECT_EVENT_X_DRIVEN_CPRG( ). This command sets the CSD 2 to connect the internal event to the slot 16 specified by the slot number when the each internal event occurs. The CSD 2 returns the connected connect number to the host 4 in the response RET( ) of this command.

A connect number is set to the argument of the host command H_UNCONNECT_EVENT_X_DRIVEN_CPRG( ). This command sets the CSD 2 to end the connection of the internal event to the slot 16 specified by the connect number when the each internal event occurs.

The host command H_ENABLE_EVENT_X_DRIVEN_CPRG( ) is provided for each event. A “connect” is added to the parameters of this command.

The host command H_DISABLE_EVENT_X_DRIVEN_CPRG( ) is provided for each event.

The host commands H_SET_MAX_EVENT_DRIVEN_CPRG( ), H_SET_EVENT_X_DRIVEN_CPRG_HOST_PARAM( ), and H_SET_EVENT_X_DRIVEN_CPRG_CONFIG( ) are provided for each event. A “connect” is added to the parameters of their commands.

According to [3. Internal event-driven CPRG startup function (multi-event, multi-slot)], one or more of the following effects can be obtained simultaneously for the CSD 2 in association with internal events. In the case of multi-slot, multiple programs to be started in association with internal events are registered by the host 4. In the case of multi-connection, it is possible to specify multiple types of programs to be in association with a single event. In the case of independent instance type, it is possible to start an independent instance for each program in association with one event. In the case of the same instance type, it is possible to start multiple programs in association with a single event in sequence on a single instance. In the case of multiple events, it is possible to specify multiple types of internal events to be linked with the start of the CPRG 24.

[4. GC Driven CPRG Startup Function]

Of the internal event-driven CPRG startup functions described above, in particular, the function of starting the CPRG 24 in association with the GC.

In the GC driven CPRG startup function, in addition to the startup function of the internal event-driven CPRG 24, a new function can be added to the GC itself to achieve a new effect not seen in the above simple internal event-driven CPRG startup function.

The GC driven CPRG startup function may be combined with any of the internal event-driven CPRG startup functions described above, and for simplicity of explanation, it is described here based on the example of combining it with [2. Internal event-driven CPRG startup function (basic type)].

[4.1. GC Driven CPRG Startup Function (Basic Type)]

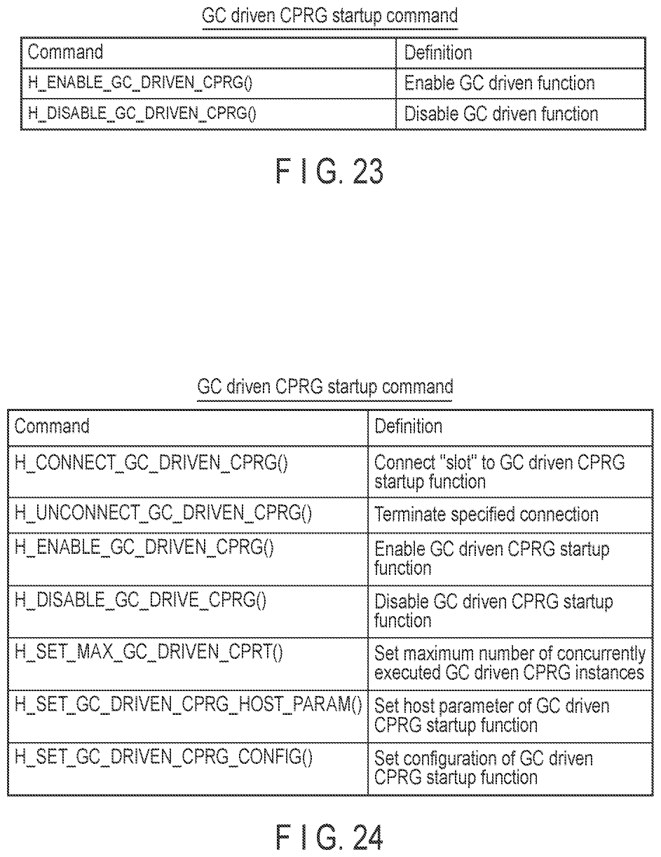

FIG. 23 is a diagram illustrating an example of host commands to realize a combination function of [2. Internal event-driven CPRG startup function (basic type)] and the GC driven CPRG startup function.

A host command H_ENABLE_GC_DRIVEN_CPRG( ) enables the GC driven function.

A host command H_DISABLE_GC_DRIVEN_CPRG( ) disables the GC driven function.

Note that GC driven CPRG startup is, in addition to the basic type of the internal event-driven CPRG startup [2. Internal event-driven CPRG startup (basic type)], combinable with any of [2.2. Internal event-driven CPRG startup function supporting multi-instance] to [3.4. Multi-event, multi-slot, multi-connection, internal event-driven CPRG startup function], or multi-extension of the above. In this case, “EVENT” or “EVENT_X” of the host command can be replaced by “GC”.

FIG. 24 is a diagram illustrating an example of host commands to realize a combination function of [2.2. Internal event-driven CPRG startup function supporting multi-instance] to [3.4. Multi-event, multi-slot, multi-connection, internal event-driven CPRG startup function] and GC driven CPRG startup function.

A slot number is set to the argument of the host command H_CONNECT_GC_DRIVEN_CPRG( ), as with the host command H_CONNECT_EVENT_DRIVEN_CPRG( ). The host command H_CONNECT_GC_DRIVEN_CPRG( ) sets the CSD 2 to connect the GC to the slot 16 specified by the slot number during the GC, i.e., to startup the CPRG 24. The CSD 2 returns the connect number to the host 4 in the response RET( ) of this command. If a different slot number from the connected slot number is specified in the argument, the CSD 2 returns the new connect number to the host 4 in the response RET( ).

The connect number is set to the argument of the host command H_UNCONNECT_GC_DRIVEN_CPRG( ), as with the host command H_UNCONNECT_EVNET_DRIVEN_CPRG( ). The host command H_UNCONNECT_GC_DRIVEN_CPRG( ) sets the CSD 2 to end the connection of the GC with the slot 16 specified by the connect number during the GC.

A host command H_ENABLE_GC_DRIVEN_CPRG( ) enables the GC driven function, as with the host command H_ENABLE_EVENT_DRIVEN_CPRG( ).

A host command H_DISABLE_GC_DRIVE_CPRG( ) disables the GC driven function, as with the host command H_DISABLE_EVENT_DRIVE_CPRG( ).

A host command H_SET_MAX_GC_DRIVEN_CPRG( ) sets the maximum number of GC driven CPRG instances that can be executed concurrently, as with the host command H_SET_MAX_EVENT_DRIVEN_CPRG( ).

A host command H_SET_GC_DRIVEN_CPRG_HOST_PARAM( ) sets the host parameters of the GC driven CPRG 24, as with the host command H_SET_EVENT_DRIVEN_CPRG_HOST_PARAM( ).

A host command H_SET_GC_DRIVEN_CPRG_CONFIG( ) sets the configuration of the GC driven function, as with the host command H_SET_EVENT_DRIVEN_CPRG_CONFIG.

Note that the host commands defined in [2. Internal event-driven CPRG startup function] are H_ENABLE_EVENT_DRIVEN_CPRG( ) and H_DISABLE_EVENT_DRIVEN_CPRG( ).

The host command defined in [2.2. Internal event-driven CPRG startup function supporting multi-instance] is H_SET_MAX_EVENT_DRIVEN_CPRG(num).

The host commands defined in [2.3. Internal event-driven CPRG startup function with host parameter setting function] are (1) H_ENABLE_EVENT_DRIVEN_CPRG (host_param), (2) H_ENABLE_EVENT_DRIVEN_CPRG_HOST_PARAM (host_param), (3) H_SET_EVENT_DRIVEN_CPRG_HOST_PARAM (instance no, host_param).

The host commands defined in [2.4. Internal event-driven CPRG startup function with configuration function] are (1) H_ENABLE_EVENT_DRIVEN_CPRG (configuration), and (2) H_SET_EVENT_DRIVEN_CPRG_CONFIG (configuration).

The host commands defined in [3.1. Single Event, multi-slot, single connection, internal event-driven CPRG startup function] are

(1) H_ENABLE_EVENT_DRIVEN_CPRG (*, slot),

(2) H_DISABLEE_EVENT_DRIVEN_CPRG (*),

(3) H_SET_MAX_EVENT_DRIVEN_CPRG (*),

(4) H_SET_EVENT_DRIVEN_CPRG_HOST_PARAM (*), and

(5) H_SET_EVENT_DRIVEN_CPRG_CONFIG (*).

The host commands defined in [3.2.1. Single event, multi-slot, multi-connection (independent instance type), internal event-driven CPRG startup function] are

(1) H_CONNECT_EVENT_DRIVEN_CPRG( ),

(2) H_UNCONNECT_EVENT_DRIVEN_CPRG( ),

(3) H_ENABLE_EVENT_DRIVEN_CPRG (*, connect),

(4) H_DISABLE_EVENT_DRIVEN_CPRG (*, connect),

(5) H_SET_MAX_EVENT_DRIVEN_CPRG (*, connect),

(6) H_SET_EVENT_DRIVEN_CPRG_HOST_PARAM (*, connect), and

(7) H_SET_EVENT_DRIVEN_CPRG_CONFIG (*, connect).

The host commands defined in [3.2.2. Single event, multi-slot, multi-connection (same instance type), internal event-driven CPRG startup function] are

(1) H_CONNECT_EVENT_DRIVEN_CPRG( ),

(2) H_UNCONNECT_EVENT_DRIVEN_CPRG( ),

(3) H_ENABLE_EVENT_DRIVEN_CPRG (*, connect),

(4) H_DISABLE_EVENT_DRIVEN_CPRG (*, connect),

(5) H_SET_MAX_EVENT_DRIVEN_CPRG (*, connect),

(6) H_SET_EVENT_DRIVEN_CPRG_HOST_PARAM (*, connect), and

(7) H_SET_EVENT_EVENT_DRIVEN_CPRG_CONFIG (*, connect).

The host commands defined in [3.3. Multi-event, multi-slot, single-connection, internal event-driven CPRG startup function] are:

(1) H_ENABLE_EVENT_X_DRIVEN_CPRG( ),

(2) H_DISABLE_EVENT_X_DRIVEN_CPRG( ),

(3) H_SET_MAX_EVENT_X_DRIVEN_CPRG( ),

(4) H_SET_EVENT_DRIVEN_X_CPRG_HOST_PARAM( ),

(5) H_SET_EVENT_DRIVEN_X_CPRG_CONFIG( ),

(6) H_ENABLE_EVENT_DRIVEN_CPRG (*, event, slot),

(7) H_DISABLE_EVENT_DRIVEN_CPRG (*, event),

(8) H_SET_MAX_EVENT_DRIVEN_CPRG (*, event),

(9) H_SET_EVENT_DRIVEN_CPRG_HOST_PARAM (*, event), and

(10) H_SET_EVENT_DRIVEN_CPRG_CONFIG (*, event).

The host commands defined in [3.4. Multi-event, multi-slot, multi-connection, and internal event-driven CPRG startup function] are:

(1) H_CONNECT_EVENT_X_DRIVEN_CPRG( ),

(2) H_UNCONNECT_EVENT_X_DRIVEN_CPRG (*, connect),

(3) H_ENABLE_EVENT_X_DRIVEN_CPRG (*, connect),

(4) H_DISABLE_EVENT_X_DRIVEN_CPRG (*, connect),

(5) H_SET_MAX_EVENT_X_DRIVEN_CPRG (*, connect),

(6) H_SET_EVENT_X_DRIVEN_CPRG_HOST_PARAM (*, connect), and

(7) H_SET_EVENT_X_DRIVEN_CPRG_CONFIG (*, connect).

The GC performed by the FTL is described in [Step 3: GC] of [Operation of FTL/GC]. In the present embodiment, the process of [Step 3-2: Data movement of valid data storing units] in the process of Step 3 is changed as follows when the GC driven function is enabled.

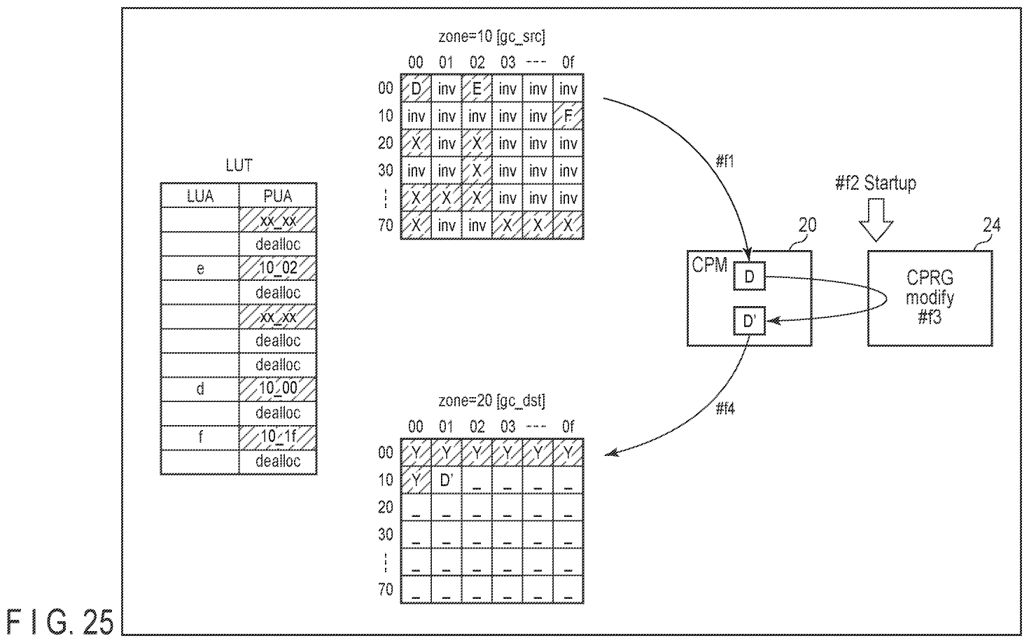

FIG. 25 is a diagram illustrating [4. GC driven CPRG startup function].

The CSDC 28 reads the valid data “D” from “gc_src”, and stores the valid data “D” into the CPM 20 (#f1).

The CSDC 28 starts the CPRG 24 in association with the GC driven function (#f2).

The CPRG 24 performs a computational operation on data “D” in the CPM 20 read from “gc_src”, and outputs the processing result “D′” to the CPM 20 (#f3).

It is acceptable if the result of the CPRG 24 processing is no change. In this case, instead of outputting the same data as the input data, the method of returning the information “no change” may be acceptable.

The CSDC 28 stores the output result “D′” of the CPRG 24 into the zone of “gc_dst” (#f4).

If the processing result of the CPRG 24 is unchanged, the same data as that read from “gc_src” is stored into the zone of “gc_dst”.

The following process, which corresponds to [Step 3-3: Update LUT], is the same as that described in [Step 3: GC] of [Operation of FTL/GC] above.

The CSD 2 of the present embodiment allows the application to make the desired data change at the timing of the zone movement of valid data by the GC.

The input data and output data are stored into the CPM 20, and the start and end timings of the use of these data storage areas are recognized by the CSDC 28. Therefore, the management of buffer area acquisition and release is performed by the CSDC 28. The CPRG 24 stores the output data into the buffer area that is allowed to be used by the CSDC 28.

The buffer management method by the CSDC 28 is not limited. A fixed buffer area may be allocated according to the CPRG instance number, or a buffer area may be allocated dynamically at each CPRG instance startup. The CPRG instance can recognize where the buffer area allocated to itself is by, for example, a CSD parameter “csd_param”.

For simplicity of explanation, hereinafter, it is assumed that to which address in the CPM 20 each data of input to the CPRG 24 from the CSDC 28 by the “csd_param” and output to the CSDC 28 from the CPRG 24 by the “csd_param” and “csd_ret” is allocated can be distinguished by the cpm buffer number. However, instead of the cpm buffer number, the cpm address may be used to distinguish. The cpm address is expressed as an integer with a large number of digits, such as 0x123456789abc0000, while the cpm buffer number is expressed as an integer with a small number of digits, such as 1 to 10.

The CSDC 28 is used to transit the cpm buffer number storing the input data to the CPRG 24 via “csd_param”. The CPRG 24 returns the CSDC 28 whether or not the data has been modified by a computational operation of the CPRG 24, and the cpm buffer number storing the output data if the data is modified, via “csd_param” and “csd_ret”.

The following is an example of a “csd_param” configuration with/without data modification by the CPRG 24 in the CSD 2 of the present embodiment, and a status of the cpm buffer.

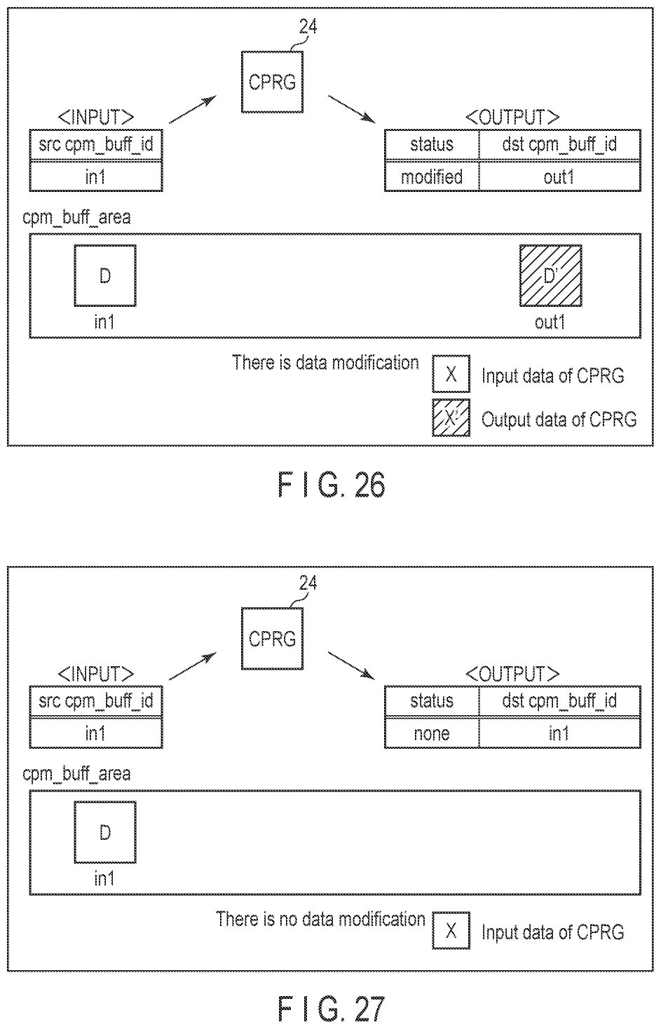

FIG. 26 is a drawing illustrating the configuration of the “csd_param” and the status of the cpm buffer when there is data modification.

FIG. 27 is a drawing illustrating the configuration of the “csd_param” and the status of the cpm buffer when there is no data modification.

The “csd_param” of the input data (INPUT) to the CPRG 24 includes a cpm buffer number “src_cpm_buffer_id” of the CPM 20. The “csd_param” of the output data (OUTPUT) of the CPRG 24 includes a “status” and a cpm buffer number “dst_cpm_buff_id” of the CPM 20. If there is a modification, “modified” is set to the “status” to the “csd_param” from the CPRG 24. In the case of no modification, “none” is set to the “status” to the “csd_param” from the CPRG 24. In the case of modification, “out1” indicative of the storage location of the output data in the CPM 20 is set to the cpm buffer number “dst_cpm_buff_id” of the “csd_param” from the CPRG 24. In the case of no modification, “in1” indicative of the storage location of the input data in the CPM 20 is set to the cpm buffer number “dst_cpm_buff_id” of the “csd_param” from the CPRG 24.

In this example, the storage location of the input and output data in the CPM 20 is specified by the cpm buffer number, but these parameters may be omitted if the buffer number available to the CPRG instance is uniquely determined in some other way. If there are multiple buffer numbers available to the CPRG instance and it is necessary to specify which buffer number is used, it is necessary to transmit the buffer location used by the “csd_param”, etc., as in FIGS. 26 and 27.

In addition, the information about the presence or absence of modification and whether the cpm buffer number of “dst” matches the cpm buffer number of “src” are the same value for the CSDC 28. For this reason, it is acceptable to either eliminate the parameter “with/without modification” or to specify the value of “dst_cpm_buff_id” when “no modification” is specified.

Hereinafter, the functions developed based on [4.1. GC driven CPRG startup function (Basic type)], that is, [4.2.1. Single SRC unit, GC driven CPRG startup function] to [4.3.5. GC driven CPRG startup function with DST address addition function] are explained.

[4.2. SRC Unit-Related Functions]

[4.2.1. Single SRC Unit, GC Driven CPRG Startup Function]

This function is a development of [4.1. GC driven CPRG Startup Function (Basic type)].

In this example, at the time of one time GC driven CPRG startup, the number of the SRC units selected for GC readout is one, and the number of the DST units selected for GC writing is one. The LUAs of the SRC unit and the DST unit do not change.

In [4.1. GC driven CPRG startup function (Basic type)], the size of the data transmitted to the CPRG 24 is undefined. The size of the data transmitted to the CPRG 24 is aligned to the unit in this function. Therefore, the size of the input data is uniform. Furthermore, in this function, LUA is added to the parameters of the input data.

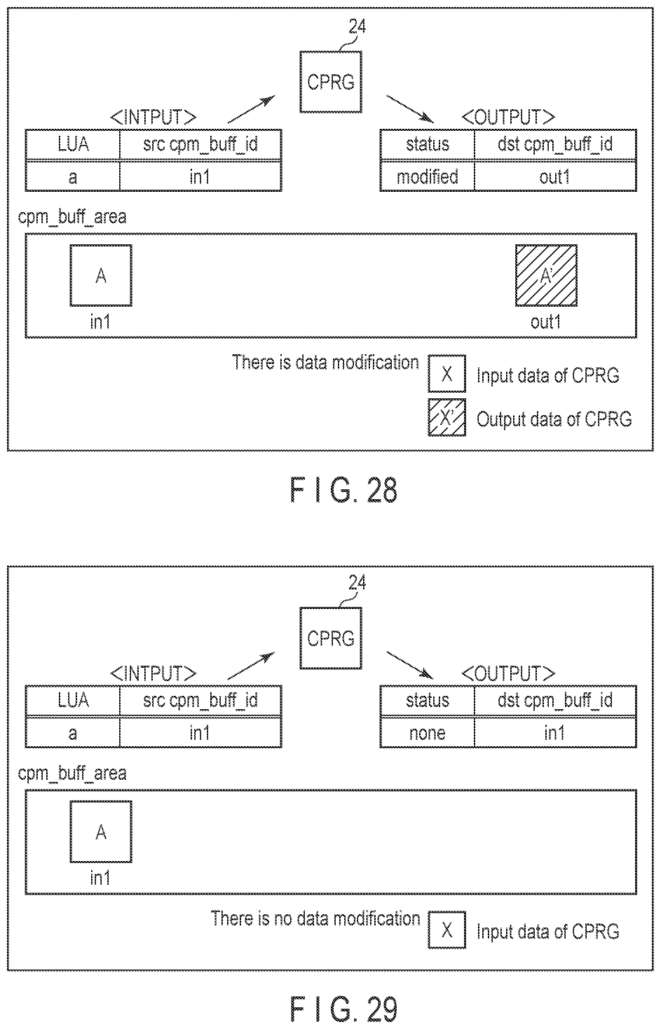

FIG. 28 is a diagram illustrating the configuration of the “csd_param” and the status of the cpm buffer when data is modified by the CPRG 24.

FIG. 29 is a diagram illustrating the configuration of the “csd_param” and the status of the cpm buffer when data is not modified.

The “csd_param” of the input data to the CPRG 24 includes the cpm buffer number src_cpm_buff_id and LUA of the CPM 20. The “csd_param” of the output data of the CPRG 24 includes the “status” and the cpm buffer number dst_cpm_buffer_id of the CPM 20. If data is modified, “modified” is set to the “status” of the “csd_param” from the CPRG 24. If data is not modified, “none” is set to the “status” of the “csd_param” from the CPRG 24.

According to this function, exclusive process of the LUT updates becomes easier. Since the data update unit coincides with the unit that is the address conversion unit by the LUT, the CSDC 28 performs the same processing as the LUT update in the conventional GC, and thus, the host write and GC write can be exclusive.

Exclusive processing at the time of LUT update in the conventional GC is achieved by checking whether or not the location of the corresponding LUA in the LUT still points to the PUA of “gc_src” just before the update.

Furthermore, according to this function, the CPRG 24 can recognize LUA of “gc_src” and “gc_dst”, which are GC targets. Therefore, the CPRG 24 can change the data processing according to the LUA of the GC target, thereby improving the flexibility of the processing.

In addition, when this function is combined with [2.3. Internal event-driven CPRG startup function with host parameter setting function], the user application related to the host 4 and CPRG 24 can specify the conditions, etc., for which LUA range the process is to be performed.

The effect of combining the present function with [2.3. Internal event-driven CPRG startup function with host parameter setting function] is achieved similarly when the present function is combined with [4.2.2. Each of multiple SRC units, GC driven CPRG startup function] to [4.3.5. GC driven CPRG startup function with DST address addition function]

[4.2.2. Each of Multiple SRC Units, GC Driven CPRG Startup Function]

This function is a modification of [4.2.1. Single SRC unit, GC driven CPRG startup function], which allows multiple units to be set to the “src” units for one time GC driven CPRG startup.

In this example, the number of the DST units is equal to the number of the SRC units, and the LUA of each DST unit is assumed to be unchanged from the LUA of each SRC unit.

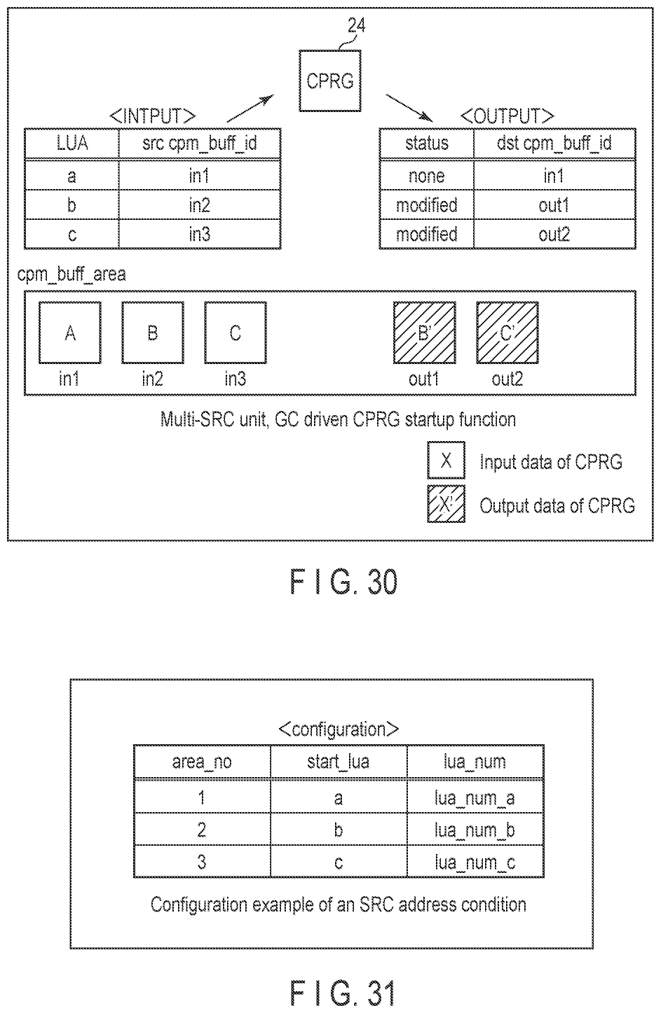

FIG. 30 is a diagram illustrating an example of parameters of the input data to the CPRG 24 and parameters of the output data from the CPRG 24.

The CSDC 28 can specify multiple LUAs and src cpm buffer numbers for the CPRG 24. For each input unit, the CPRG 24 specifies whether or not there is data modification and where to store the output data. The fact that parameters can be omitted for duplicate information is described in [4.1.1. GC driven CPRG startup function] and [4.2.1. Single SRC unit, GC driven CPRG startup function].

This function has the following advantages over [4.2.1. Single SRC unit, GC driven CPRG startup function].

(1) The CPRG 24 is able to modify data across multiple units.

(2) Because the number of times the CPRG 24 is started can be reduced in performing the GC of the same data, the overhead of starting the CPRG 24 can be reduced.

The number of the units to be transmitted at one time may be a system-defined value, or it may be configured by the host 4 for GC driven CPRG startup.

In the present embodiment, it is assumed that the LUT update is equivalent to the conventional FTL. That is, the unit of exclusion for data update by the host 4 and GC is treated as a unit.

[4.2.3. GC Driven CPRG Startup Function with SRC LUA Address Conditionally Specified]

[4.2.3.1. GC Driven CPRG Startup Function (Configuration Method) with SRC LUA Address Conditionally Specified]

This function specifies, as a configuration of the GC driven function, the conditions for the LUA to start the CPRG 24.

Using the configuration setting function described in [2.4. Internal event-driven CPRG startup function with configuration function], the host 4 sets the LUA condition for GC driven CPRG startup for the CSD 2. The method of specifying the LUA condition is determined in advance for the CSD 2 and the host 4. For example, a method such as “list of LUA ranges that enable GC driven CPRG” may be determined.

FIG. 31 is a diagram illustrating a configuration example of an SRC address condition. For each area of the source unit “area_no”, the value of the starting LUA “start_lua” and the number of LUAs “lua_num” are set.

As described in [2.4. Internal event-driven CPRG startup function with configuration function], the configuration value may be set with a configuration setting command and allowed to be dynamically changed during the period when the GC event-driven CPRG startup is enabled. Allowing dynamic switching makes it easier to change the target area dynamically and increases convenience.

Furthermore, with the method of changing the CPRG 24 to be started based on the LUA condition in combination with the function of [3.2. Single event, multi-slot, multi-connection, and internal event-driven CPRG startup function], such as “slot_a” for LUA condition “A” and “slot_b” for LUA condition “B”, and so on, many types of GC driven CPRG 24 processes can be efficiently performed.

[4.2.3.2. GC Driven CPRG Startup Function (Two-Step CPRG Method) with SRC LUA Address Conditionally Specified]

This function is to add a function to [4.1. GC driven CPRG startup function], the function to connect the event to two CPRGs 24 in which a first CPRG 24 performs determination of address condition to return a Boolean value to the CSDC 28 while a second CPRG 24 switches startup or not in accordance with the return value of the first CPRG 24.

The first CPRG 24 is referred to as a first stage CPRG 24, and the second CPRG 24 is referred to as a second stage CPRG 24. The slot that stores the first stage CPRG 24 is referred to as a first-stage slot. The slot that stores the second stage CPRG 24 is referred to as a second-stage slot.

The host command for this function is obtained by slightly extending the host command used in the GC driven function.

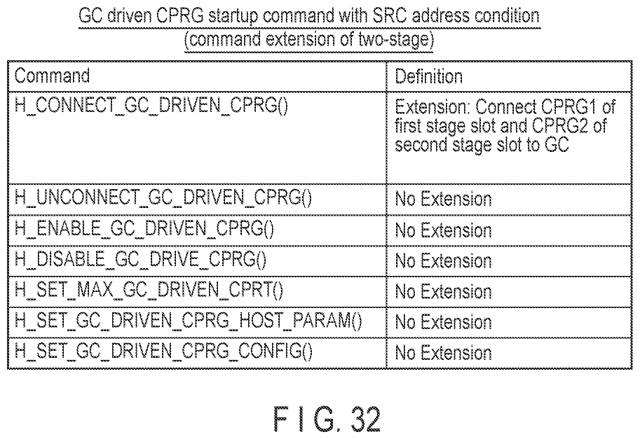

FIG. 32 is a diagram illustrating an example of host commands used in this function.

A host command H_CONNECT_GC_DRIVEN_CPRG( ) is extended, and instructs the GC to connect CPRG1 of the first stage slot and CPRG2 of the second stage slot to be started during the GC.

Other host commands H_UNCONNECT_GC_DRIVEN_CPRG( ), H_ENABLE_GC_DRIVEN_DRIVEN_CPRG( ), H_DISABLE_GC_DRIVE DRIVE_CPRG( ) H_SET_MAX_GC_DRIVEN_CPRG( ), H_SET_GC_DRIVEN_HOST_PARAM( ), H_SET_GC_DRIVEN_CPRG_CONFIG( ) are not extended.

In this function, the CSDC 28 performs the following process instead of [CPRG startup] described in [4.1. GC driven CPRG startup function (basic type)].

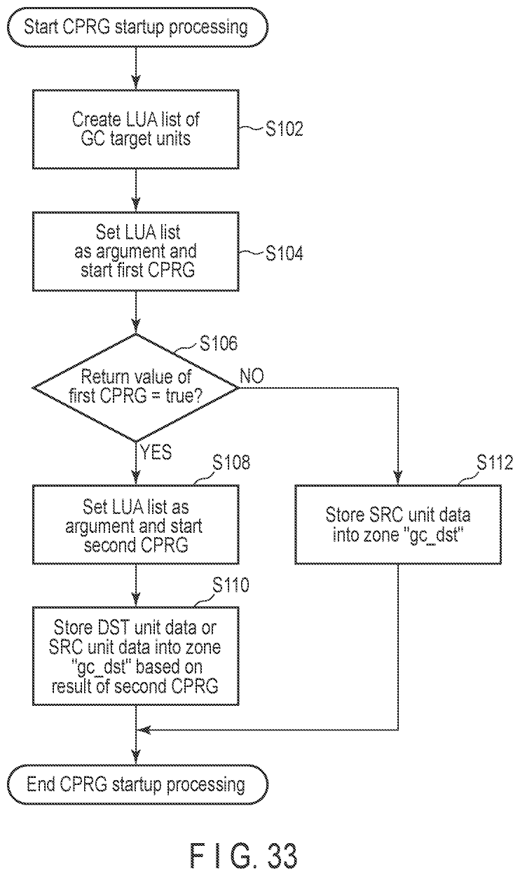

FIG. 33 is a flowchart illustrating an example of the CPRG startup function of [4.2.3.2. GC driven CPRG startup function (two-step CPRG method)].

The CSDC 28 creates an LUA list of the units of GC target (S102). The CSE 18 sets the LUA list as an argument and starts the first CPRG (S104).

The CSE 18 determines if the return value of the first CPRG is true (the first CPRG has been executed successfully) (S106).

If the return value of the first CPRG is true (Yes in S106), the CSE 18 sets the LUA list as an argument and starts the second CPRG (S108).

The CSE 18 stores, based on the result of second CPRG, the DST unit data or SRC unit data into the zone of “gc_dst” (S110).

If the return value of the first CPRG is not true (No in S106), the CSE 18 stores the SRC unit data into the zone of “gc_dst” (S112).

After S110 or S112, the CPRG startup is ended.

In this flowchart, the following two processes are omitted.

(Process 1) Transfer (or Copy) the unit data from “gc_src” to the SCM 22.

(Process 2) Storing the SRC unit data to be transmitted to the second CPRG 24 into the CPM 20.

These two processes may be performed at any timing as long as the following conditions are met.

(Process 1) is performed before S112.

(Process 2) is performed before S108.

The actual processing timing may vary depending on the following conditions from the implementation of the CSD.

(Condition 1) In storing the unit data read from “gc_src” into the CPM 20, the unit data is directly transferred (or copied) to the CPM 20 or transferred (or copied) to the CPM 20 after it has been transferred (or copied) to the SCM 22.

(Condition 2) The difference between whether or not the unit data needs to be read to determine whether or not each unit in “gc_src” is valid.

(Condition 3) Whether or not to use the CPM 20 as the unit data deployment destination regardless of whether or not the second-stage CPRG 24 is called. When the CPM 20 is used, the condition 1 and the condition 2 can be combined in the same step.

This function allows more flexible determination of the LUA condition than [4.2.3.1. GC driven CPRG startup function (configuration method) with SRC LUA address conditionally specified].

However, because of the two-step CPRG startup, the overhead may become larger than [4.2.3.1. GC driven CPRG startup function (configuration method) with SRC LUA address conditionally specified].

[4.2.4. GC Driven CPRG Startup with SRC PUA

Address in Reverse Order Specified] This function adds a function that enables the order in which the valid data storing units are read from the “gc_src” to be performed in a PUA descending order, instead of a PUA ascending order, in the zone, to [4.1.1. GC driven CPRG startup function]. This function is one of the configuration functions for the GC driven CPRG function.

The number of the SRC units in a single GC driven CPRG startup may be one or more, but it is easier to get the effect when there are multiple SRC units.

The GC processes the valid data storing units in one zone in order. In the example where there is one SRC unit at the time of one CPRG startup, if N valid data storing units are included in a zone, the CPRG is started N times for that zone. Whether the unit processed by the GC each time the CPRG 24 is started comes from the first unit in the zone or the last unit in the zone depends on this function.

The following describes the GC driven CPRG startup when the number of the SRC units is three.

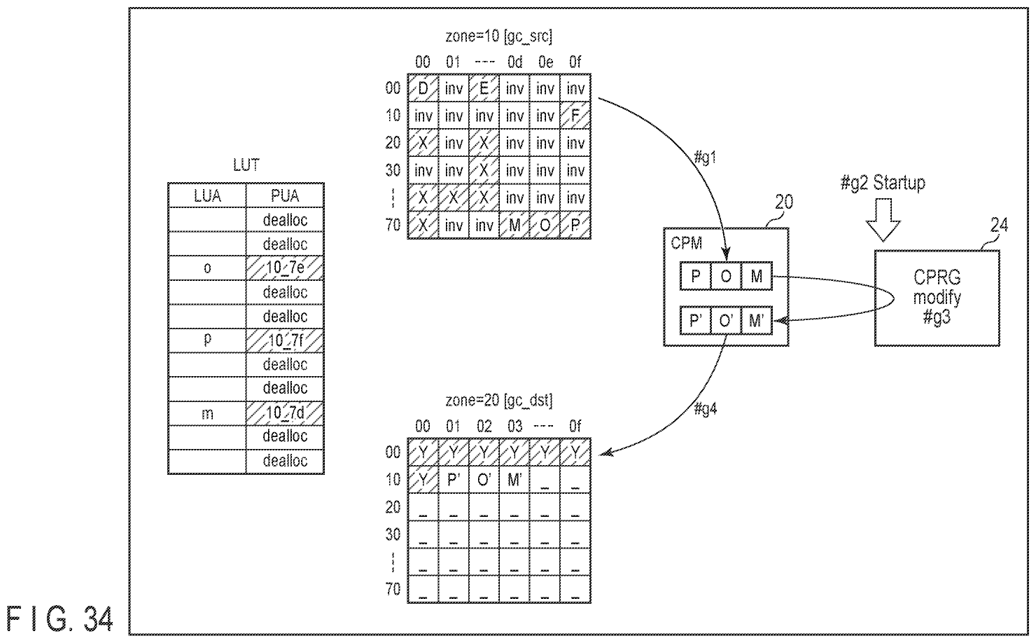

FIG. 34 is a diagram illustrating the GC driven CPRG startup with SRC PUA address reverse order specified.

“Zone=10” is selected for “gc_src”.

The CSDC 28 reads the data “P”, “O”, and “M” of the valid data storing units of “gc_src” in the order of the number of the valid data storing units required to be transmitted to the CPRG 24, starting from the last address of the PUA, and store them into the CPM 20 (#g1).

The CSDC 28 starts the CPRG 24 in association with the GC driven function (#g2).

The CPRG 24 performs a computational operation using the data in the CPM 20 read from the “gc_src” as input, and outputs the processing results “P′”, “O′” and “M′” to the CPM 20 (#g3).

It is also acceptable if the result of the processing by the CPRG 24 is no change. In this case, instead of outputting the same data as the input data, the method of returning the information “no change” is acceptable.

The CSDC 28 stores output results “P′”, “O′”, and “M′” of the CPRG 24 into the zone of “gc_dst” (#g4).

If the result of processing by the CPRG 24 is unchanged, the same data as that read from the zone of “gc_src” is stored into the zone of “gc_dst”.

This function has the advantage of improving the flexibility of data processing by the CPRG 24 as compared to the GC driven CPRG startup function with the processing order of PUA at GC fixed in ascending order.

That is, when processing data across multiple units, having both ascending and descending options expands the variety of data processing that can be performed. This is especially effective in cases where the data are stored in multiple units and the metadata that points to the content of the data is placed at the latter portion of the PUA.

It is relatively possible to have an arrangement where administrative data such as metadata is placed at the latter portion of the PUA. In the case where the data includes the content and metadata describing the content, if the write order of the host 4 to the CSD 2 is such that the content is stored into the first portion and the metadata is stored into the latter portion of the PUA, the PUA for the metadata is placed at the latter portion of the PUA. Even if the metadata is placed at the first portion of the LUA space, the PUA is allocated according to the write order.

For example, an application where the host 4 writes a series of log data, and then finally writes metadata indicating the contents of the log data is applicable to the above.

A specific example of this function is described in [5.5.2.2 (Embodiment CASE C) Compaction of log] below.

Although there are various possible implementations of the configuration specification method, two examples are shown below.

### First Example: Order Specification Method for “Gc_Src” PUA

It is possible to specify “forward” or “reverse” in the configuration. Forward and reverse are defined as specifying whether to use ascending or descending order for “gc_src” PUA. When there is a dynamic configuration switching request from the host 4, even if there is a switching request in the middle of writing of zone “gc_src” or “gc_dst”, the CSDC 28 shall perform the order switching as soon as possible.

### Second Example: Order Specification Method for Host Write

It is possible to specify “forward” or “reverse” in the configuration. Forward and reverse are defined to specify whether the host write is performed for PUA in ascending or descending order. A single “gc_dst” is written in either the “forward” or “reverse” order, and the zone attribute of whether the write was done in the “forward” or “reverse” order is managed for each zone. When there is a dynamic request from the host 4 to change the configuration, the order of the zone “gc_dst” currently being written is not changed. The scan order of “gc_src” is changed at the timing when the next write to “gc_dst” starts.

Comparing the first and second examples, the first example has the advantage of requiring less implementation resources because there is no need to manage attribute for each zone. On the other hand, the second example makes it possible for the application to deliberately select “whether the host 4 wants to know first the data written in the latter portion or first the data written in the first portion” which is as intended for the host 4. This has the advantage that the order processing can be explicitly specified.

[4.3. DST Unit Related Functions]

[4.3.1. GC Driven CPRG Startup Function with DST Allocate Function]

This function provides a function to specify the deallocation of units to be processed from the CPRG 24 to the CSDC 28 by changing the following two points to [4.1. GC driven CPRG startup function].

(Change 1) Add a parameter to the information returned from the CPRG 24 to the CSDC 28 to indicate whether it is deallocated or not.

(Change 2) The CSDC 28 performs the following processing for the unit designated for deallocation by the CPRG 24.

(Process 1) Writing to “gc_dst” is omitted.

(Process 2) It is determined whether the PUA of the target unit remains valid in the LUT update process (whether the PUA indicated by the target LUA in the LUT is still a unit corresponding to “gc_src”). If it remains valid, the PUA of the LUA is changed to “deallocate”. If it is invalid (pointing to another PUA) at the time of validity check, no LUT update is performed.

This function can be combined with any of the functions described in [4.1. GC driven CPRG startup function].

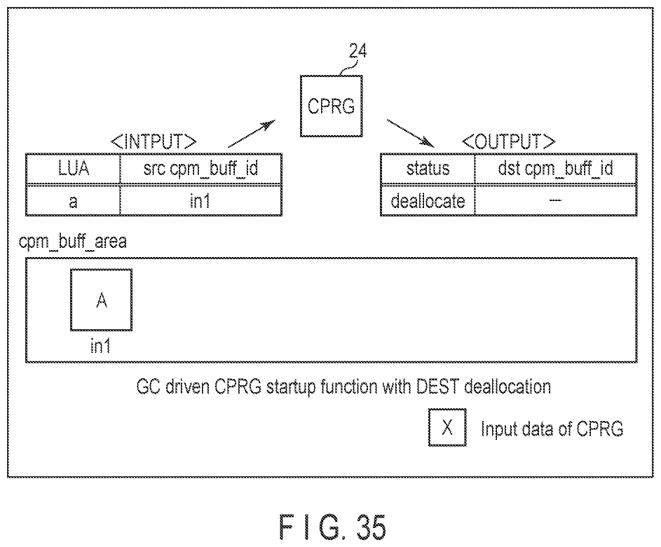

FIG. 35 illustrates a parameter example when this function is combined with [4.2.1. Single SRC unit, GC driven CPRG startup function].

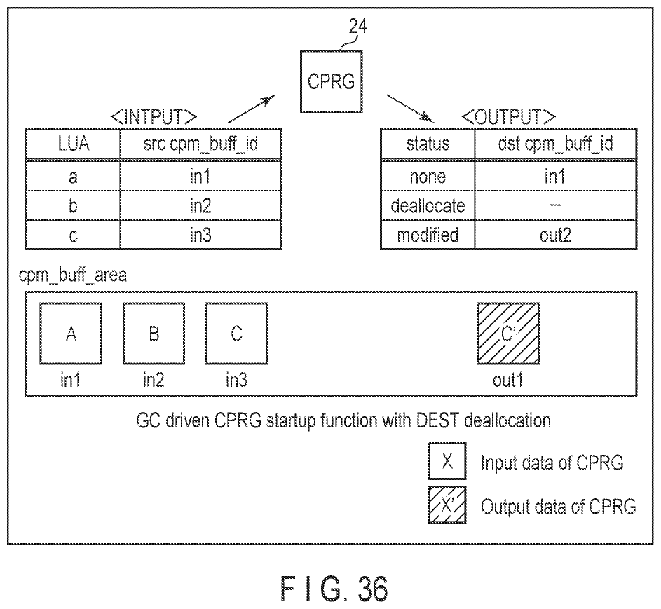

FIG. 36 illustrates a parameter example when this function is combined with [4.2.2. Each of multiple SRC units, GC driven CPRG startup function].

In both cases, “deallocate” indicative of deallocate is added to “status” of the parameter from the CPRG 24. Furthermore, when the “status” is “deallocate”, the value of “dst_cpm_buff_id” is invalid.

This function will allow for further compaction of the usage size of the storage medium 10 at the timing of GC.

[4.3.2. GC Driven CPRG Startup Function with DST Address Order Change Function]

The following two changes have been made to the [4.1. GC driven CPRG startup function] to provide a function to set the replacement of the writing order of the units to be processed to “gc_dst” at the time of the return from the CPRG 24 to the CSDC 28.

(Change 1) A parameter to set the LUA is set to the entry order of the information returned from the CPRG 24 to the CSDC 28. The CPRG 24 shall be allowed to change the LUA order of the output for the LUA order of the input.

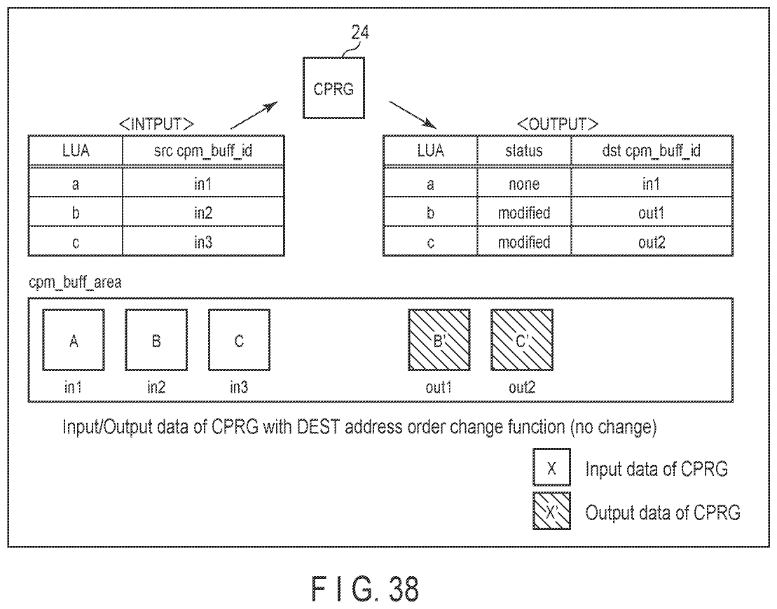

The information returned from the CPRG 24 to the CSDC 28 is in a table structure shown in “OUTPUT” of FIG. 30. Assuming that the writing is performed to the units of “gc_dst” in the order of entries in this table, and that a parameter for setting the LUA to the entry of the table is added, the information returned from the CPRG 24 to the CSDC 28 is in a table structure shown “OUTPUT” of FIG. 38.

(Change 2) The CSDC 28 performs writes to “gc_dst” and updates the LUT in the order of entries output from the CPRG 24.

This function can be combined with any of the functions described in [4.1. GC driven CPRG startup function]. Here are two cases in which this function is combined with the [4.2.2. Each of multiple SRC units, GC driven CPRG startup function] described below.

### (Example 1) No Change in Address Order

Although the GC driven function with DST address order change function is used, the following is an example of when the CPRG 24 uses the GC driven function without changing the address order.

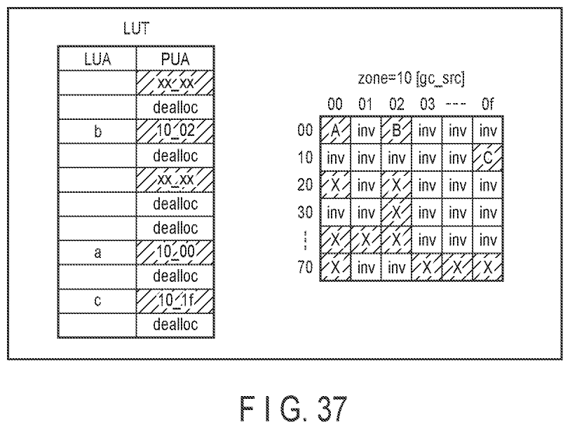

FIG. 37 is a diagram illustrating the status of the LUT and “gc_src” at the start of GC driven CPRG startup.

FIG. 38 is a diagram illustrating an example of the input and output of the CPRG 24 when the CPRG 24 is started with three units of LUAs (=a, b, and c) as input. Here, the order of “a”, “b”, and “c” of the input LUA are also maintained in the order of the output LUA.

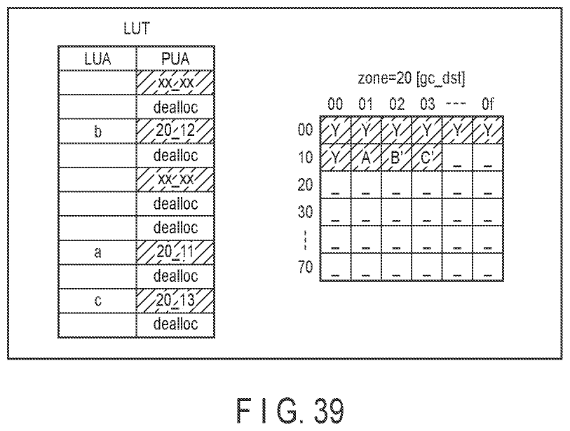

In response to this output, the order in which the CSDC 28 writes unit data to “gc_dst” is the order of LUA (=a), LUA (=b), and LUA (=c). FIG. 39 is a diagram illustrating the status of LUT and “gc_dst” after saving unit data to “gc_dst” (zone=20) and updating the LUT in this order.

“A” is stored in PUA (=20_11) which is the destination of LUA (=a), “B′” is stored in PUA (=20_12) which is the destination of LUA (=b), and “C′” is stored in PUA (=20_13) which is the destination of LUA (=c).

(2) When there is a Change in Address Order

A case where the CPRG 24 changes the address order with the GC driven function with DST address order change function is explained.

It is assumed that the status of the LUT and “gc_src” at the start of the CPRG startup process by the GC driven function is the same as the status of Example 1 of FIG. 37.

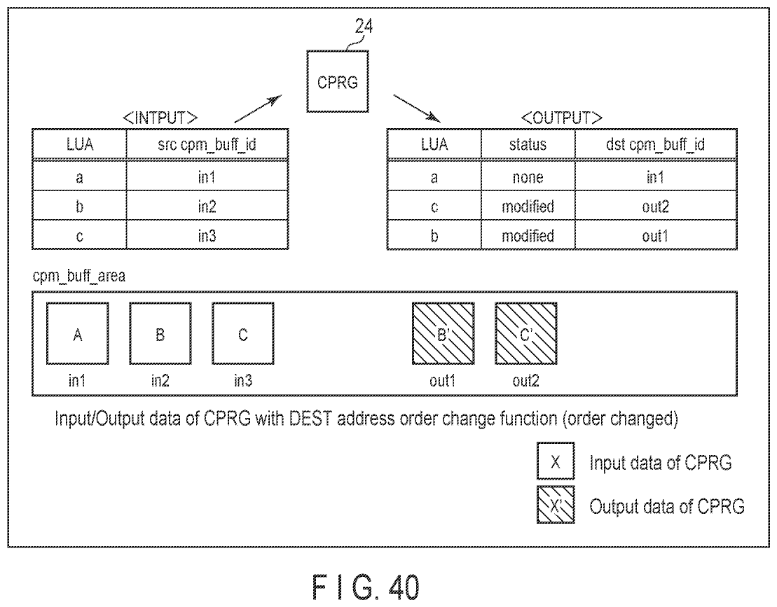

FIG. 40 is a diagram illustrating an example of the input and output of the CPRG 24 when the CPRG 24 is started using three units of LUAs (=a, b, and c) as input.

In this example, the order of the input is LUA (=a), LUA (=b), and LUA (=c) while the order of the output is replaced by LUA (=a), LUA (=c), and LUA (=b).

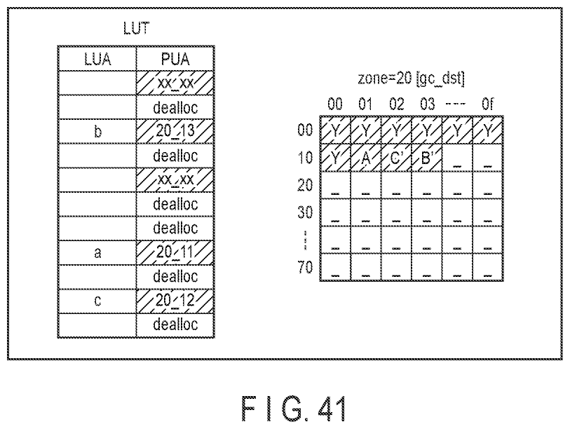

The order in which the CSDC 28 receives this output and writes data to units in “gc_dst” in order of LUAs (=a, c, and b). FIG. 41 illustrates the status of the LUT and “gc_dst” after storing the unit data into “gc_dst” (zone=0x20) and updating the LUT in this order.

The destination of LUA (=c) is PUA (=20_12) where “C′” is stored. The destination of LUA (=b) is PUA (=20_13) where “B′” is stored.

From example 1, it can be understood that even with the DST address order change function, order replacement may be avoided.

Furthermore, by comparing the results of examples 1 and 2, it can be understood that, depending on how this feature is used, the CPRG 24 can change the order in which the PUAs are placed while maintaining the contents of each LUA.

This feature allows applications to take actions such as placing a series of meaningful data in a continuous manner on the PUA.

This makes it possible to obtain the effect of improving the reading speed of data placed on a series of PUAs. Furthermore, considering that data with similar attribute tend to have uniform write workloads, it is possible to obtain an effect that leads to improved GC efficiency later on.

[4.3.3. GC Driven CPRG Startup Function with DST Unit Attribute Specification Function]

The following two changes have been made to [4.1. GC driven CPRG startup function] to provide a function to set the attribute information of the data of the unit to be processed when returning from the CPRG 24 to the CSDC 28.

(Change 1) A parameter is provided that allows setting of data attribute information in the entry for each unit of information returned from the CPRG 24 to the CSDC 28.

(Change 2) The CSDC 28 writes, according to the data attribute information for each unit output from the CPRG 24, the data of the corresponding unit to the zone “gc_dst” based on the attribute of data. For example, write attribute and read attribute can be defined for the attribute of data.

The technique of FTL writing data to different zones based on data attribute is described in the previous section [Use zone based on data attribute]. In this function, the attribute information to be used for the technology is determined by the GC driven CPRG 24 and feeds back the determined result to the CSDC 28.

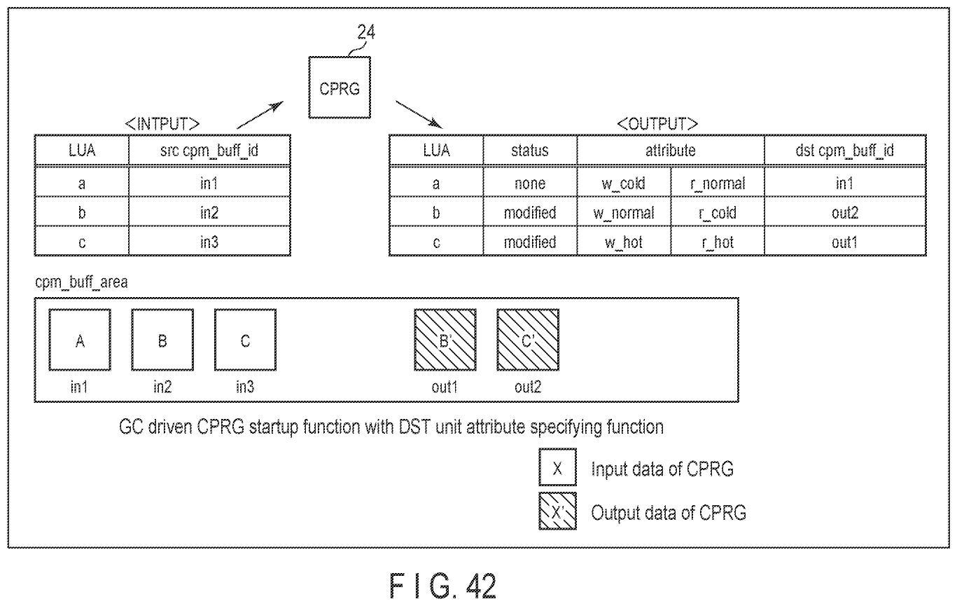

FIG. 42 shows an example of the parameters when this function is applied to [4.3.2. GC driven CPRG startup function with DST address order change function].

Here, as the data attribute, whether the write attribute is w_hot/w_normal/w_cold or not for each unit, or whether the read attribute is r_hot/r_normal/r_cold or not for each unit can be set. The write attribute indicates how often the target LUA data is overwritten or written. The read attribute indicates how often the target data is read. Note that the classification of data attribute is not limited thereto, and may be divided in other ways.

[4.3.4. GC Driven CPRG Startup Function with DST Unit Carry Over Function]

[4.3.4.1. Overview]

This function adds the following three functions to [4.1. GC driven CPRG startup function].

(Function 1) The function that the CPRG 24 sets for the CSDC 28 to carry over the processing of the unit designated as input.

(Function 2) The function that, when the CPRG 24 completes the processing of a unit that has been carried over, the CPRG 24 sets the pay off to the CSDC 28.

(Function 3) The function that the CSDC 28 requests the CPRG 24 to pay off units that are being carried over.

The carry over of processing means that the result of processing cannot be output in the current CPRG call, but is fixed in some point in subsequent CPRG calls.

The following sections explain “carry over and pay off” and “pay off request” in that order.

[4.3.4.2. Carry Over and Pay Off]

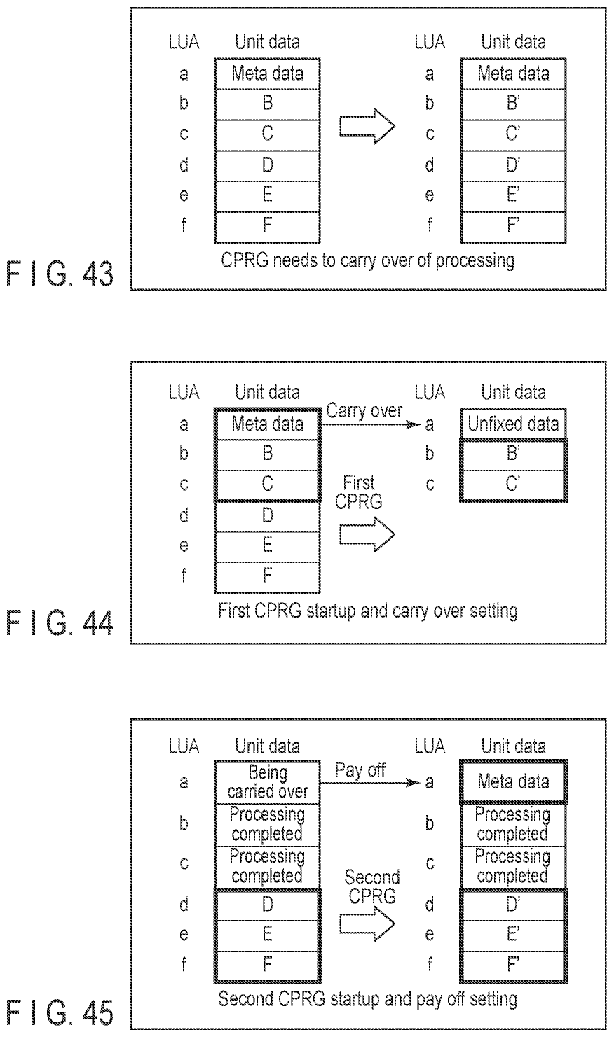

FIG. 43 illustrates an example of what kind of CPRGs need to carry over of processing.

It is considered that there are data stored in LUAs (=a, b, c, d, e, f), and the metadata for LUAs (=b to f) is stored in the first LUA (=a). For the sake of simplicity, it is assumed that the data is arranged on the PUA in the same order as the LUA. By writing data in LUAs (=a to f) sequentially in a host write, it is expected that they are likely to be sequential on the PUA as well.

It is assumed that, after the CPRG first modifies the data stored in LUAs (=b to f), the metadata generated using the results is stored in the first LUA (=a).

If the CPRG is started for the first time and unit data of LUAs (=a to f) are all input, this operation is possible.

However, if only three unit data are input in the first CPRG started, unit data are input to LUAs (=a, b, and c) in the first CPRG, and unit data are input to LUAs (=d, e, and f) in the second CPRG.

In such a case, the carry over and pay off of the units are to process the data in LUAs (=b and c) and carry over the process for the unit data in LUA (=a) in the first CPRG, and to process the data in LUAs (=d, e, and f) and complete the process for the unit data in LUA (=a) to pay off in the second CPRG.

FIG. 44 is a diagram illustrating the first CPRG and the carry over settings.

FIG. 45 is a diagram illustrating the second CPRG and pay off settings.

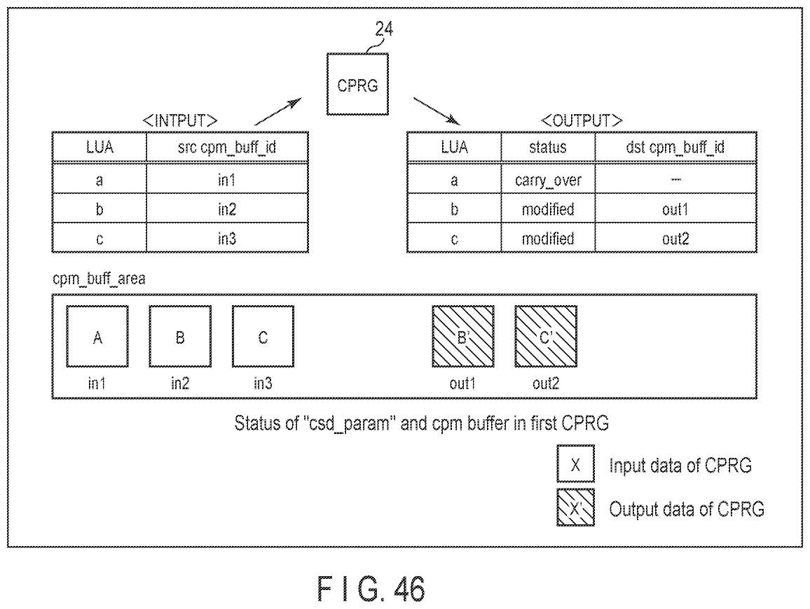

FIG. 46 is a diagram illustrating input/output of the “csd_param” and usage of the cpm buffer in the first CPRG. In the first CPRG startup, the CPRG 24 set “carry_over” to status of the entry of LUA (=a) in the output “csd_param”.

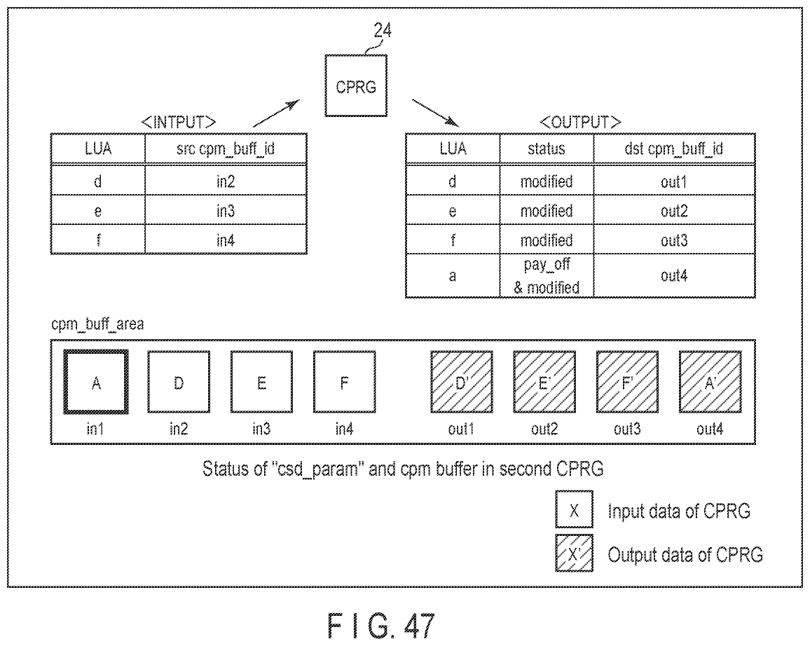

FIG. 47 is a diagram illustrating input/output of the “csd_param” and usage of cpm buffer in the second CPRG. In the second CPRG startup, the CPRG 24 adds an entry of LUA (=a) to the output “csd_param”, and sets pay_off and processing result to a status, that is, status=pay off and modified, and describes the output destination number “out4” in a cpm buffer number of the DST (dst_cpm_buff_id).

The cpm buffer number “in1” for storing the input data of LUA (=a) that has been set to carry over is reserved as it is. The reason is that the input data of LUA (=a) which has not been completed processing for the CPRG 24 and CSDC 28 cannot be released even after the first call of the CPRG 24.

The corresponding input buffer is released only after the CPRG 24 has completed its pay off and the CSDC 28 has completed the corresponding processing.

Also, although not explicitly shown here, the CSDC 28 is in the process of processing data with LUA (=a) and internally maintains information on how many PUAs are in the “gc_src”. This information is also stored in the CSDC 28 until the processing associated with the pay off of LUA (=a) is ended.

Since carrying over unit processing involves delays in releasing these resources, it is effectively accompanied by restrictions on the upper limit of the number that can be carried over at the same time, etc.

[4.3.4.3. Pay Off Request]

In the example of [4.3.4.1. Carry over and pay off], the pay off of the unit of LUA (=a) that was set to carry over in the first CPRG was performed in the second CPRG. Depending on the size of the series of data, the determination of the data of the unit carried over in the first CPRG may not be fixed when the second CPRG is started, and may continue to be carried over to the third and fourth CPRGs.

On the other hand, it is convenient for the CSDC 28 to return the zone “gc_src” to a “free” zone as soon as it finishes processing all valid data storing units in the zone “gc_src”.

For this reason, pay off request by the CSDC 28 is to specify that “current CPRG cannot be carried over, and thus, unit being carried over should be payed off”.

The CPRG 24 must finalize the units that are being carried over and pay off in the startup of the times it receives a pay off request.

That is, when using the carry over function, the CPRG 24 needs to be used on the premise set by the CSD 2 that the unit to be carried over must be able to fix the data at the timing when the pay off request is received.

[4.3.5. GC Driven CPRG Startup Function with DST Address Addition Function]

The following two changes have been added to [4.1. GC driven CPRG startup function] to allow the CPRG 24 to instructs the CSDC 28 that unit data is written to an LUA that has not been specified as an input.

(Change 1) The function to set an entry for writing to a new LUA in the information returned from the CPRG 24 to the CSDC 28.

(Change 2) CSDC 28 performs the following processes for the unit specified by the CPRG 24 to write to the new LUA.

(Process 1) Write to “gc_dst”

(Process 2) Omit checking whether the PUA of the target unit remains valid in the LUT update process (check whether the PUA indicated by the target LUA in the LUT is still the corresponding unit of “gc_src”) and update the PUA of the corresponding LUA.

This function has a similar parameter structure with [4.3.1. GC driven CPRG startup function with DST allocate function], [4.3.2. GC driven CPRG startup function with DST address order change function], [4.3.3. GC driven CPRG 24 startup function with DST unit attribute specification function], and [4.3.4. GC driven CPRG startup function with DST unit carry over function] which involve the specification of attribute of the DST units, but is largely different in characteristics.

The reason is that this function cannot check the exclusion of the host write and the CPRG write in the LUT update process. In other words, in this function, the exclusion of the host write and The CPRG write must be performed at the application level across the host 4 and the CPRG 24.

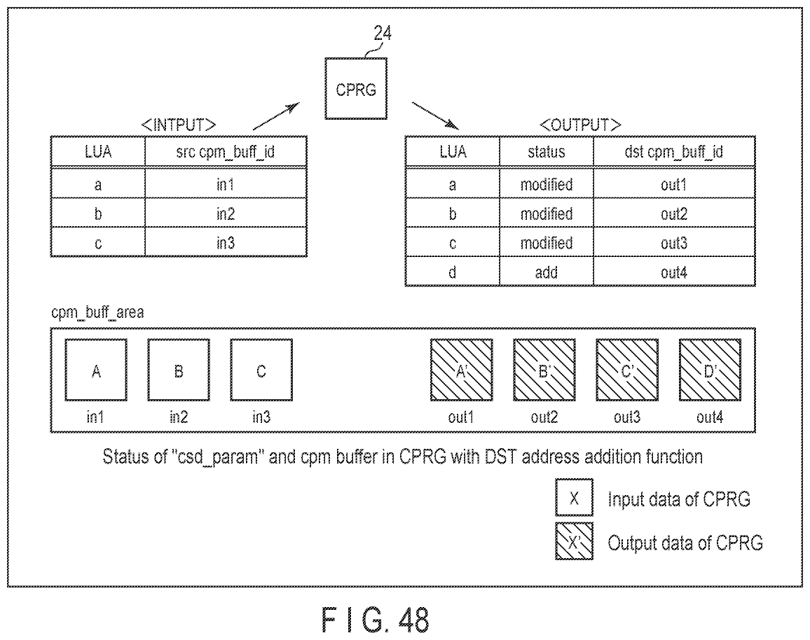

FIG. 48 is a diagram illustrating an example of the “csd_param” and cpm buffers for this function.

This function will increase the degree of freedom of the CPRG 24. For example, it is able to handle modifications of the input data that increase the data size.

By combining the present function with [4.3.1. GC driven CPRG 24 startup function with DST allocation function], it is possible to support the movement of LUA of a unit.

According to [4. GC driven CPRG startup function], the overlap between data reading and writing by the application and data reading and writing by the GC can be reduced. As the overlap is reduced, the WAF is improved, and the life of the CSD 2 can be extended. With the reduction of overlap, the performance is improved by the reduction of the I/O processing. It becomes possible to perform data processing across multiple units on one GC driven CPRG 24. It is possible to start the GC driven CPRG 24 by specifying the SRC address. By making it possible to execute the GC in a zone in descending order as well as in ascending order of PUA, it becomes possible to perform data processing in the GC linked CPRG 24 in the order of increasing PUA value. It is possible to improve WAF and extend the life of the CSD 2 by the data deallocation function. By specifying the order of data placement after GC, it becomes possible to apply processing such as gathering data of the same type at successive addresses, thereby improving performance. It is possible to improve the WAF associated with the use of different zones based on the data attribute, and to improve the performance associated with it. When the data conversion processing is not completed only by the input data to one GC driven CPRG 24, it is possible to perform data conversion processing using the input data to multiple GC driven CPRGs 24. The GC driven CPRG 24 makes it possible to perform data conversion processing in which the output data is larger in size than the input data.

### Application Example

### Basic Example

Application example where the GC driven CPRG startup functions of [4.2.1. Single SRC unit, GC driven CPRG startup function] to [4.3.5. GC driven CPRG startup function with DST address addition function] are advantageous with what kind of data structure and what kind of CPRG 24.

The GC driven CPRG startup function is advantageous when a large amount of data reading and a large amount of data writing back are performed in duplicate, as in (Example 1) to (Example 7) above.

### (Example 1) Data Conversion (Single Unit, Same LUA)

A use case where data is stored in a format storing a meaningful data set in a single LUA unit, and where there is a large amount of data in a similar format in a single LUA unit is considered.

A B-tree structure, which is used in many data systems, is the best example of such a use case.

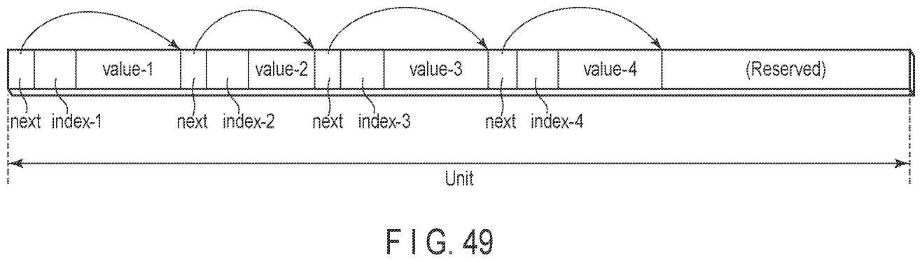

FIG. 49 illustrates a unit structure, schematically represented by the image of a leaf page of a B-tree structure.

For example, this unit structure is used as a membership list of a certain association, where a membership number is entered in “index” and a name-and-address is entered in “value”. The association in this example has a huge number of members, and there are a large number of units with this structure.

One day, some addresses were changed due to land readjustment. It is recommended to update addresses in the directory, but there is no need to hurry because the old address will work for a while.

This kind of data conversion is performed by the GC driven CPRG startup function.

Although the size of individual “values” may increase or decrease due to data conversion, the unit has a sufficient size margin so that the total size of “values” rarely, if ever, exceeds the unit size.

In this case, the following functions are effective.

[4.2.1. Single SRC unit, GC driven CPRG startup function]

The following functions are also more effective when used in conjunction.

[1.1. Asynchronous notification setting function from CPRG to host]

[2.3. Internal event-driven CPRG startup function with host parameter setting function]

The host 4 specifies the LUA range of a unit be processed with respect to CPRG 24 started by GC driven using “host_param” set by [2.3. Internal event-driven CPRG startup function with host parameter setting function].

The CPRG 24 processes for each unit, and records the progress of the process (creating a list of LUAs related to data which have processed).

When a certain amount of progress of the process is recorded, the CPRG 24 reports the progress to the host 4 by asynchronous notification by using [1.1. Asynchronous notification setting function from CPRG to host]. At that time, if there is a record that the conversion by the CPRG 24 was not performed because the total size of “values” exceeds the unit size by the conversion, the CPRG 24 also informs the host 4 of the record.

The host 4 can check the progress, and can perform the conversion by itself only for the data for which the conversion by the CPRG 24 has not been performed. To do this, for example, in a B-tree, it is necessary to perform a processing across multiple units such as splitting the leaves, updating the contents of the upper nodes, and the like.

As the GC progresses, the units to be processed will eventually be converted in one way or another.

The host 4 can stop the GC driven function when it confirms the completion of all unit conversions to be processed.

If the unit to be processed is not easily selected for “gc_src” for some reason, such as being stored in a zone with a lot of cold data, and the host 4 may not finish converting all the data within the desired period of time, the host 4 will stop the GC driven function without waiting for the completion of all unit processing by the CPRG 24, and only the unprocessed data may be converted by the host 4.

[Example of Data Content and Address Focus]

### (Example 2) Data Conversion (Multiple Units, Same LUA)

This example is a use case where the data to be processed spans multiple units.

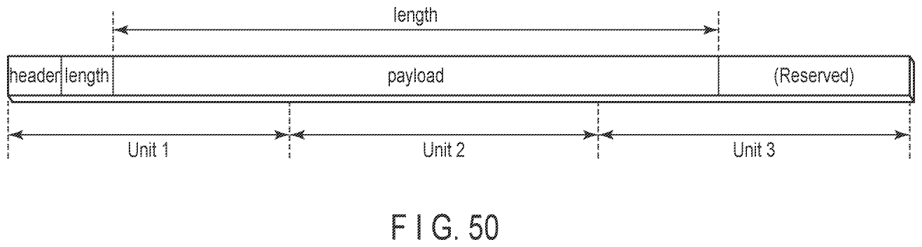

FIG. 50 illustrates a case where a single chunk of meaningful data is spread across multiple units.

In the example of FIG. 50, the value of the length in the first unit is determined only after the data in the payload is determined. If the example in FIG. 50 is a list of names, there may be a case where the payload will include the information such as member number, name, address, phone number . . . and one day there is a reorganization of the area, and the address should be replaced with a new one.

In such a case, the following function is effective.

[4.2.2. Each of multiple SRC units, GC driven CPRG startup function]

In addition, depending on the separation of data and processing, the following function may also be effective.

[4.3.4. GC driven CPRG startup function with DST unit carry over function]

### (Example 3) Compaction

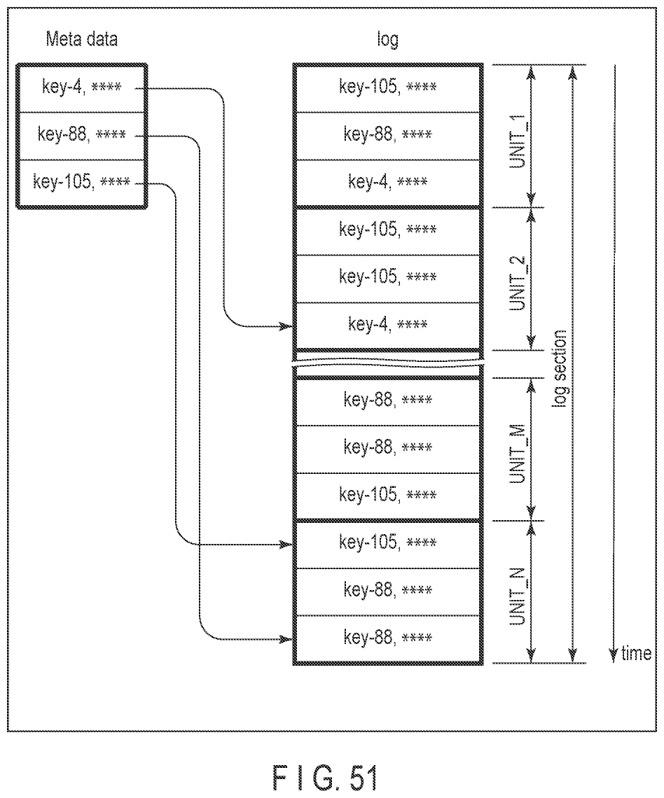

This example is a use case where there is a large amount of unnecessary data in the data to be processed. An example of unnecessary data is duplicate log data. FIG. 51 illustrates the log structured data structure, which is used in many data systems.

Here, transaction logs each consisting of a combination of “key”, “value” (**** in the figure) are sequentially written in a log area across multiple units in chronological order. Here, it is assumed that only the most recent transaction with the same “key” is valid.

Metadata includes a pointer that points to the location of the valid data for each “key” in a chunk of log called a log section. The metadata is written into the CSD after the log section has been written, and thus the metadata is located behind the log section in a PUA space.

The compaction of the log section by the application is, for such logs, to remove duplicate key data, create a new log with only latest data of each key, and destroy the original log section.

However, even without waiting for the compaction of this application, it is understood from the metadata that unit_1 and unit_M in FIG. 51 are never referenced because they include only unnecessary data.

In this case, it is considered effective if the zone movement of unit_1 and unit_M is omitted in the GC, and treat them as deallocate in the LUT.

In this case, a combination of each of the following functions is effective.

[4.2.4. GC driven CPRG startup function with SRC PUA addresses specified in reverse order]

[4.3.1. GC driven CPRG startup function with DST allocate function]

### (Example 4) Change of PUA Address Order

In this example, considered is a case where multiple types of data with different meanings are randomly mixed and mingled on a PUA.

If one application on the host 4 is writing data while another application is writing data, the CSD 2 will receive a mix of write requests from these two applications.

As a result, even if each application were to perform sequential writes, the two types of data would be stored in a mixed manner on the PUA.

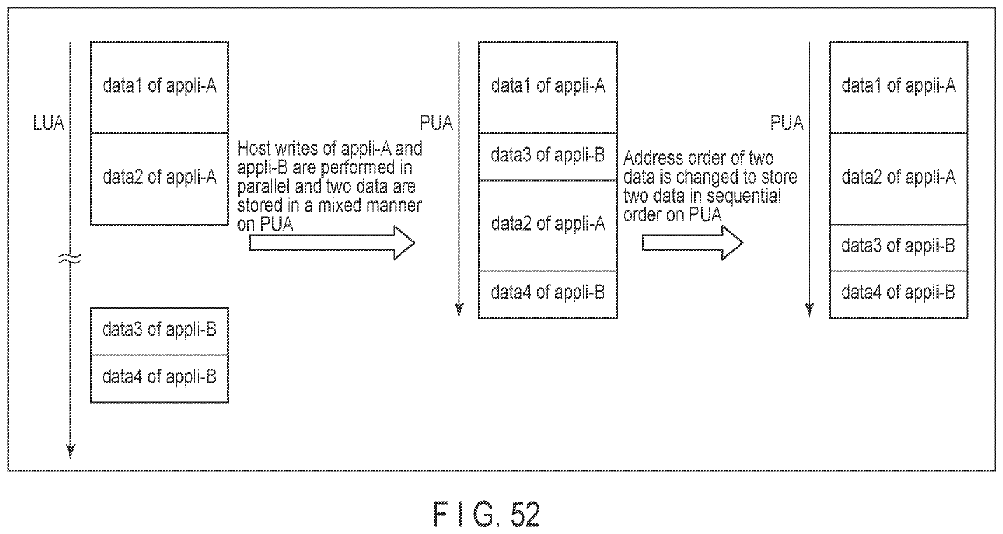

FIG. 52 illustrates the PUA address order change in Example 4.

In such a case, storage performance can be expected to be improved by changing the placement so that items of similar type of LUA (or items with the same namespace) are placed consecutively on the PUA.

In this case, a combination of each of the following functions is effective.

[4.2.2. Each of multiple SRC units, GC driven CPRG startup function]

[4.3.2. GC driven CPRG startup function with DST address order change function]

### (Example 5) Sorting Based on Data Attribute

The present example is for data that has hot/cold attributes depending on the data.

Considered is the data of message posting system on a social network service, where user ID is stored in the “key”, and messages of the user are stored in the “value”.

Messages of popular users can be assigned the attribute “read hot”, and sorted into zones with fast read performance, thereby improving system performance while keeping cost increases to a minimum.

In this case, the following function is effective.

[4.3.3 GC driven CPRG startup function with DST unit attribute specification function]

### (Example 6) Data Movement

If data is moved on a LUA space, the following functions are effective.

[4.3.1. GC driven CPRG startup function with DST allocate function]

[4.3.5. GC driven CPRG startup function with DST address addition function]

### (Example 7-1) Data Conversion (Data Format Change, Size Reduction)

Considered is a data structure in which the number of units of data after conversion is less than before conversion as a result of format conversion of data that stored in multiple units.

In this case, the following function is effective.

[4.3.1. GC driven CPRG startup function with DST allocate function]

### (Example 7-2) Data Conversion (Data Format Change, Size Expansion)

Considered is a data structure in which the number of units of data after conversion is more than before conversion as a result of format conversion of data that stored in multiple units.

In this case, the following function is effective.

[4.3.5. GC driven CPRG startup function with DST address addition function]

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A computational storage drive, comprising:
a first memory configured to store a program;
a second memory configured to be accessed when the program is executed;
a storage medium configured to store data from a host;
a processor configured to execute the program and to perform data processing with respect to the data stored in the second memory or the storage medium; and
a controller configured to perform, upon a request from the host, data write to the storage medium, data read from the storage medium, or control of an asynchronous event which is a process independent of the request from the host, wherein
the program is configured to issue an asynchronous event notification when an asynchronous event occurs;
the controller is configured to transmit the asynchronous event notification to the host when the controller is allowed by the host to transmit the asynchronous event notification.

2. The computational storage drive of claim 1, wherein the asynchronous event notification includes a log.

3. A computational storage drive, comprising:
a first memory configured to store a plurality of programs;
a second memory configured to be accessed when any of the programs is executed;
a storage medium configured to store data from a host;
a processor configured to execute any of the programs and to perform data processing with respect to the data stored in the second memory or the storage medium; and
a controller configured to perform, upon a request from the host, data write to the storage medium, data read from the storage medium, or control of an asynchronous event independent of the request from the host, wherein
the controller is configured to make, when an asynchronous event set by the host occurs, the processor execute at least one of the programs related to the asynchronous event.

4. The computational storage drive of claim 3, wherein the controller is configured to make the processor execute at least one of the programs designated by the host when the asynchronous event occurs.

5. The computational storage drive of claim 3, wherein the controller is configured to make the processor execute at least one of the programs related to the asynchronous event if event-driven program startup is enabled by the host when the asynchronous event occurs.

6. The computational storage drive of claim 3, wherein the controller is configured to make the processor simultaneously execute at least two of the programs set by the host when the asynchronous event occurs.

7. The computational storage drive of claim 3, wherein the controller is configured to make the processor execute at least one of the programs in accordance with a startup parameter set by the host when the asynchronous event occurs, the at least one of the programs being designated by the host.

8. The computational storage drive of claim 3, wherein
the controller is configured to make the processor execute at least one of the programs in accordance with a startup parameter set by the host if event-driven program startup is enabled by the host when the asynchronous event occurs, the at least one of the programs being designated by the host, and
the startup parameter is dynamically changed by the host while the event-driven program startup is enabled by the host.

9. The computational storage drive of claim 8, wherein the controller is configured to suspend changing the startup parameter after the program in execution ends when the controller receives a change request of the startup parameter from the host.

10. The computational storage drive of claim 3, wherein the controller is configured to make the processor to execute at least one of the programs related to the asynchronous event if a condition set by the host is satisfied when an asynchronous event set by the host occurs.

11. The computational storage drive of claim 3, wherein
the controller is configured to make the processor execute at least one of the programs designated by the host if event-driven program startup is enabled by the host and a condition set by the host is satisfied when the asynchronous event occurs, and
the condition is dynamically changed by the host while the event-driven program startup is enabled by the host.

12. The computational storage drive of claim 11, wherein the controller is configured to suspend changing the condition after the program in execution ends when the controller receives a change request of the condition from the host.

13. The computational storage drive of claim 3, wherein the controller is configured to make the processor execute one of the programs or at least two of the programs when the asynchronous event occurs, or wherein the controller is configured to make the processor execute one of the programs or at least two of the programs at each time when asynchronous events occur.

14. A computational storage drive, comprising:
a first memory configured to store a plurality of programs;
a second memory configured to be accessed when any of the programs is executed;
a storage medium configured to store data from a host;
a processor configured to execute any of the programs and to perform data processing with respect to the data stored in the second memory or the storage medium; and
a controller configured to perform, upon a request from the host, data write to the storage medium, data read from the storage medium, control of a garbage collection of the storage medium independent of the request from the host, wherein
the controller make the processor execute at least one of the programs related to the garbage collection while the garbage collection is performed.

15. The computational storage drive of claim 14, wherein
the storage medium includes a plurality of zones,
each of the zones includes a plurality of units,
each of the zones is a data erase unit of the storage medium,
each of the units is a data write unit of the storage medium,
each of the units includes a physical address designated by the controller,
the controller includes a lookup table which manages a corresponding relation between a logical address designated by the host and the physical address, and
the garbage collection includes
an operation to write valid data read from a first unit of a first zone among the zones to a second memory,
an operation to write the valid data read from the second memory to a second unit of a second zone among the zones,
an operation to update the lookup table such that a logical address that has been corresponded to a physical address of the first unit corresponds to a physical address of the second unit, and
an operation to allocate all units of the first zone as free units to which data can be written when writing of all of the valid data of the first zone to the second zone finishes.

16. The computational storage drive of claim 15, wherein
the garbage collection further includes
an operation to write valid data read from third units of the first zone to the second memory,
an operation to write the valid data read from the second memory to fourth units of the second zone,
an operation to update the lookup table such that logical addresses that have been corresponded to physical addresses of the third units correspond to physical addresses of the fourth units, and
an operation to allocate all units of the first zone as free units to which data can be written when writing of all of the valid data of the first zone to the second zone finishes, and
the logical addresses corresponded to the physical addresses of the third units are equal to logical addresses corresponded to the physical addresses of the fourth units.

17. The computational storage drive of claim 15, wherein
the garbage collection includes
an operation to write valid data read from a third unit within a first logical address range of the first zone to a second memory,
an operation to write the valid data read from the second memory to a fourth unit of the second zone,
an operation to update the lookup table such that a logical address that has been corresponded to physical address of the third unit corresponds to a physical address of the fourth unit, and
an operation to allocate all units of the first zone as free units to which data can be written when writing of all of the valid data of the first zone to the second zone finishes, and
the first logical address range is set by the host.

18. The computational storage drive of claim 15, wherein
the garbage collection includes
an operation to write valid data read from third units of the first zone to the second memory,
an operation to write the valid data read from the second memory to fourth units of the second zone,
an operation to update the lookup table such that logical addresses that have been corresponded to physical addresses of the third units correspond to physical addresses of the fourth units, and
an operation to allocate all units of the first zone as free units to which data can be written when writing of all of the valid data of the first zone to the second zone finishes, and
an order of physical addresses of the third units from which the valid data are read is set by the host to be an ascending or descending order.

19. The computational storage drive of claim 15, wherein, if the at least one of the programs related to the garbage collection designates the second unit of the second zone as a deallocate unit, the controller is configured to omit the operation to write data for the garbage collection to the second unit, and update the lookup table such that a condition of the second unit be deallocated.

20. The computational storage drive of claim 15, wherein the controller is configured to write the valid data read from the second memory to the second unit in an addressing order designated by the at least one of the programs related to the garbage collection.

21. The computational storage drive of claim 15, wherein the second unit of the second zone is selected based on an attribute of the valid data read from the first unit.

22. The computational storage drive of claim 15, wherein
if the at least one of the programs related to the garbage collection designates carry over the writing of the valid data to the second unit of the second zone, the controller is configured to delay writing of the valid data; and
if the at least one of the programs related to the garbage collection designates pay off the writing of the valid data to the second unit of the second zone, the controller is configured to delay updating of the lookup table.

23. The computational storage drive of claim 14, wherein
the controller is configured to make the processor execute a first program related to the garbage collection while the garbage collection is performed, and a second program related to the garbage collection if an execution result of the first program is normal.
